(19) United States
(12) Patent Application Publication
(10) Pub. No.: US 2023/0335139 A1
(43) Pub. Date: Oct. 19, 2023

(54) SYSTEMS AND METHODS FOR VOICE CONTROL IN VIRTUAL REALITY

(71) Applicant: Penumbra, Inc., Alameda, CA (US)

(72) Inventors: Joel Breton, Santa Rosa, CA (US); Danilo Silva, Thousand Oaks, CA (US); Andrew Huertas, Carson, CA (US)

(21) Appl. No.: 17/870,945

(22) Filed: Jul. 22, 2022

Related U.S. Application Data
(60) Provisional application No. 63/330,722, filed on Apr. 13, 2022.

(51) Int. Cl. G10L 17/22; G06F 3/16

(52) U.S. Cl. CPC G10L 17/22; G06F 3/167

(57) ABSTRACT

Systems and methods may provide voice control to allow a patient and/or therapist to issue voice commands to efficiently navigate to desired, appropriate VR therapy activities and exercises. Generally, a VR platform and/or voice engine may receive a voice command, identify a requested VR activity in the voice command, and cause the corresponding VR activity to be provided. In some cases, a voice command may trigger a search by a voice engine and search results, e.g., an activity or command that best matches, returned. In some embodiments, a VR therapy platform may only allow voice commands by authorized users. In some embodiments, a VR platform may provide voice control via a VR system in online and/or offline mode, where offline mode has no internet or network connection, and voice processing may be performed without a cloud server.

### CLAIM OF PRIORITY

This application is related to, and hereby claims the benefit of, U.S. Provisional Patent Application No. 63/330,722, filed Apr. 13, 2022, which is hereby incorporated by reference herein in its entirety.

### BACKGROUND OF THE DISCLOSURE

The present disclosure relates generally to virtual reality (VR) systems and more particularly to providing voice control in VR therapy or therapeutic activities or therapeutic exercises to engage a patient experiencing one or more health disorders.

### SUMMARY OF THE DISCLOSURE

Virtual reality (VR) systems may be used in various medical and mental-health related applications including various physical, neurological, cognitive, and/or sensory therapy. Generally, patients may provide input using sensors, controllers, and/or “gaze” head orientation to navigate an interface and begin an activity, exercise, video, multimedia experience, application, and other content (referred to, together, as “activities”). For an inexperienced patient, using a VR platform only a couple of times and somewhat infrequently, accessing an activity can be frustrating, drawn-out, and potentially lead to incorrect selections. Even if a supervisor or therapist is present and able to monitor a mirrored display of the head-mounted display (HMD), guiding a novice patient to an appropriate activity may be complicated and time consuming. There exists a need for a VR therapy platform to facilitate quick access to VR therapy activities and exercises using, e.g., voice commands from a participant and/or a supervisor.

As discussed herein, a VR therapy platform may provide voice control to allow a patient and/or therapist to issue voice commands to efficiently navigate to desired, appropriate VR therapy activities and exercises. Moreover, in some embodiments, a VR therapy platform may only allow voice commands by authorized users. In some embodiments, a VR platform may provide voice control via a VR system in an online mode, as well as an offline mode that is not connected to the internet and/or a network, e.g., for voice processing services.

### BRIEF DESCRIPTION OF THE DRAWINGS

FIG. 1 depicts an illustrative scenario and interface of a VR voice control system, in accordance with embodiments of the present disclosure;

FIG. 2A depicts an illustrative VR voice control system, in accordance with embodiments of the present disclosure;

FIG. 2B depicts an illustrative VR voice control system, in accordance with embodiments of the present disclosure;

FIG. 3 depicts an illustrative flow chart of a VR voice control process, in accordance with embodiments of the present disclosure;

FIG. 4 depicts an illustrative flow chart of a VR voice control process, in accordance with embodiments of the present disclosure;

FIG. 5 depicts illustrative VR voice control system interfaces, in accordance with embodiments of the present disclosure;

FIG. 6 depicts illustrative VR voice control tutorial interfaces, in accordance with embodiments of the present disclosure;

FIG. 7 depicts illustrative VR voice control system interfaces, in accordance with embodiments of the present disclosure;

FIG. 8 depicts illustrative VR voice control system interfaces, in accordance with embodiments of the present disclosure;

FIG. 9 depicts an illustrative flow chart of a VR voice control process, in accordance with embodiments of the present disclosure;

FIG. 10 depicts an illustrative scenario and interface of a VR voice control system, in accordance with embodiments of the present disclosure;

FIG. 11A is a diagram of an illustrative system, in accordance with some embodiments of the disclosure;

FIG. 11B is a diagram of an illustrative system, in accordance with some embodiments of the disclosure;

FIG. 12 is a diagram of an illustrative system, in accordance with some embodiments of the disclosure;

FIG. 13 is a diagram of an illustrative system, in accordance with some embodiments of the disclosure; and

FIG. 14 is a diagram of an illustrative system, accordance with some embodiments of the disclosure.

### DETAILED DESCRIPTION OF THE DISCLOSURE

VR activities have shown promise as engaging therapies for patients suffering from a multitude of conditions, including various physical, neurological, cognitive, and/or sensory impairments. VR activities can be used to guide users in their movements while therapeutic VR can recreate practical exercises that may further rehabilitative goals such as physical development and neurorehabilitation. For instance, patients with physical and neurocognitive disorders may use therapy for treatment to improve, e.g., range of motion, balance, coordination, mobility, flexibility, posture, endurance, and strength. Physical therapy may also help with pain management. Some therapies, e.g., occupational therapies, may help patients with various impairments develop or recuperate physically and mentally to better perform activities of daily living and other everyday living functions. Additionally, cognitive therapy and meditative exercises, via a VR platform, may aid in improving emotional wellbeing and/or mindfulness. Through VR activities and exercises, VR therapy may engage patients better than traditional therapies, as well as encourage participation, consistency, and follow-through with a therapeutic regimen. The compact sizes and portability of VR platforms allows VR therapy activities to be performed in more locations than traditional therapy and may allow freedom for some therapies to be practiced without a trained therapist present in the patient's room, e.g., performed with a family member supervising or independently. VR therapy platforms may make therapy more accessible and engaging than ever before, leading to lowered entry barriers and superior follow-through. As engaging as VR therapy activities may be, however, finding and accessing an appropriate VR activity may not always be an easy task—e.g., especially for VR novices.

The amount of VR activities available to therapists and patients for practice and therapy in a VR platform can be substantial. In some cases, VR activities are stored on the VR platform, e.g., in memory of a VR device such as a head-mounted display (HMD) and added over time. In some cases, VR activities may be downloaded from or accessed in the cloud on-demand and, e.g., there may be no apparent physical memory limit to how many VR activities that may be generally available to a therapist or patient. Finding the right VR activity is not always straightforward, even with titles, classifications, and/or descriptions available for searching and sorting.

One approach to accessing VR activities may be using content guidance through an interface that allows users to efficiently navigate activity selections and easily identify activities that they may desire. An application which provides such guidance may be referred to as, e.g., an interactive guidance application, a content guidance application, or a guidance application. VR therapy platforms may provide user interfaces to facilitate identification and selection of a desired VR activity in the form of an interactive guidance application.

Interactive content guidance applications may take various forms, such as user interfaces similar to interactive program guides or electronic program guides from web applications, television interfaces, and/or streaming device graphical user interfaces. Interface menus may feature titles, descriptions, names, artwork, categories, keywords, and more. For instance, activities may be navigated as groups based on category, content type, genre, age group, targeted impairments, cognitive and neurocognitive issues, time, popularity, and more. Selecting an item in each interface page may include advancing deeper in a hierarchy of categories.

Interactive content guidance applications may utilize input from various sources for control, including remote controls, keyboards, microphones, body sensors, video and motion capture, accelerometers, touchscreens, and others. For example, a remote-control device (such as a gaming controller, joystick(s), or similar to a television remote) may use a Bluetooth connection to transmit signals to move a cursor in a VR platform running in a head-mounted display (HMD). A connected mouse, keyboard, or other device may wirelessly transmit input data to a VR platform. In some approaches, head position, as measured by sensors in a HMD, may control a “gaze” cursor that can select buttons and interact with icons and menus in an interface of a VR platform. Similarly, body sensors may track real world arm or hand movements to facilitate menu and interface navigation. In some approaches, multiple peripherals and/or devices may be used to aid in navigation of a VR interface. Navigation of VR menus can be quite complex, especially for beginners.

In some approaches, using a keyboard to search for content in an interactive content guide may allow input of more search terms and facilitate searching titles, keywords, and metadata for available VR applications. Metadata may describe or provide information about activities but can generally be any data associated with a content item. Still, searching in a VR platform interface may not be easy, especially for a novice patient or user. Whether it is using sensors, controllers, keyboards, valuable therapy time may be expended with pre-activity interface navigation. There exists a need for a simpler interface, with minimal hardware, to quickly gain access to a VR activity appropriate for each patient.

Additionally, not every patient may experience a VR platform in the same way, and not every patient may be physically or mentally able to navigate a VR platform interface. VR therapy can be used to treat various disorders, including physical disorders causing difficulty or discomfort with reach, grasp, positioning, orienting, range of motion (ROM), conditioning, coordination, control, endurance, accuracy, and others. VR therapy can be used to treat neurological disorders disrupting psycho-motor skills, visual-spatial manipulation, control of voluntary movement, motor coordination, coordination of extremities, dynamic sitting balance, eye-hand coordination, visual-perceptual skills, and others. VR therapy can be used to treat cognitive disorders causing difficulty or discomfort with cognitive functions such as executive functioning, short-term and working memory, sequencing, procedural memory, stimuli tolerance and endurance, sustained attention, attention span, cognitive-dependent IADLs, and others. In some cases, VR therapy may be used to treat sensory impairments with, e.g., sight, hearing, smell, touch, taste, and/or spatial awareness. Additional motion required for navigating a cursor can potentially harm a patient and/or reinforce poor form in movements.

In some approaches, a therapist or supervisor may provide instructions for the patient to navigate the interface and, e.g., select a VR activity. For instance, a therapist may have a tablet or monitor with a Spectator View mirroring the patient's view in the HMD and can relay instructions to the patient to navigate. This approach can be prone to human error of both the supervisor and the patient. A therapist or supervisor may not be clear in the instructions and the patient may not comprehend the instructions and/or act correctly based the heard instructions. Coordinating the identification of buttons, icons, descriptions, and other user interface elements may take time, discussion, and patience. For instance, understanding instructions to move a cursor or gaze may vary based on, e.g., directions and magnitude of movement. Especially with patients working to improve some form of motor skills, a therapist asking for particular movements for selecting interface elements can be problematic. Such an exertion would definitely consume therapy session time and could very well risk discouragement of a patient before a therapy session even starts. There exists a need for a VR therapy platform to facilitate quick access to VR therapy activities and exercises using, e.g., voice commands.

In some approaches, a microphone incorporated into a VR system may capture and transmit voice data to the VR platform. Voice recognition systems and virtual assistants connected with the VR platform may be used to search for and/or control content and activities. For instance, a microphone connected to the HMD may be configured to collect sound coming from the patient. Voice analysis may convert the sound input to text and perform a command or search based on the detected words used. In some cases, a patient may use voice control with known phrases, keywords, and/or sample instructions prompted by the interface. Still, if the patient is new or inexperienced, he or she may still have trouble navigating to a particular VR activity, e.g., as required by a therapist or therapy plan. Spending time navigating to an activity could be an unnecessary expenditure of valuable time and effort during a limited time for therapy session.

In some approaches, a therapist or supervisor may relay instructions for the patient to use for voice control to navigate the interface and/or initiate a VR activity. For instance, a therapist may use Spectator View to mirror and relay instructions for the patient to speak. This approach can also be prone to human error of both the supervisor and the patient. For instance, words may be lost in the relay, a patient's speech may be garbled or distorted, and a patient's memory may be inconsistent at times. Moreover, repeating a therapist's instructions is redundant and time consuming. There exists a need for a VR therapy platform to facilitate quick access to VR therapy activities and exercises using, e.g., voice commands, from a patient and/or a supervisor.

In some embodiments, as disclosed herein, a microphone incorporated to a VR system (e.g., fixed to the HMD) may be configured to capture audio from a supervising therapist in addition to (or instead of) a patient issuing voice commands. For instance, rather than navigate using controls or motion, or relay instructions, a therapist may address a voice control system of a VR platform directly to quickly access a particular VR activity for the patient to experience. In some embodiments, a microphone may be positioned on the HMD to capture both the patient and the therapist. In some embodiments, a sensitivity level of a microphone may be configured to capture both the patient and the therapist. For instance, microphone gain may be adjusted to, e.g., boost the signal strength of the microphone level. In some embodiments, a microphone may use an amplifier or a pre-amp. In some embodiments, a microphone with high gain may be configured to filter out background noise and normalize sound levels of, e.g., voices. Voice detection may use, e.g., a wake word prior to receiving a query or command. In some embodiments, voice processing may ignore noises outside of the voice that provided the wake word. In some embodiments, voice processing may identify and/or determine if a speaker is authorized to give the VR platform commands.

In some embodiments, a therapist may issue remote commands while supervising the patient in VR activities using telehealth communications via the internet. For instance, a video call may be integrated into the VR platform experience and, e.g., voice commands may be issued by the therapist remotely.

In some approaches to enabling voice control, a remote voice server may be used for, e.g., voice processing. When a user provides an input comprising a command (e.g., whether via the wake-up word while close to the device or far away, or by pressing a dedicated button on a device such as a remote control), a user's input speech may be streamed to an automatic speech recognition (ASR) service and then passed to a natural language processing (NLP) service. Often, the output of the ASR is fed to the NLP module for analysis. Some platforms today may combine the ASR and NLP modules for faster and more accurate interpretation. Still, whenever a voice control system relies on a cloud server to provide voice services such as ASR/NLP, a network (or internet) connection is necessary. If the VR platform relies on a cloud voice server and a VR therapy session is conducted in a place without a network connection—e.g., a remote area, an indigent neighborhood, and/or an older hospital or other institution—the VR interface cannot be navigated with voice control. A VR therapy session, e.g., with a novice or impaired patient, would be forced to navigate the interface by translating supervisor instructions into arm, head, and/or body movements. Again, this may be a problematic expenditure of time and effort for a therapist and/or a patient.

As discussed herein, a VR therapy platform may provide voice control to allow a patient and/or therapist to issue voice commands to efficiently navigate to desired, appropriate VR therapy activities and exercises. Moreover, in some embodiments, a VR therapy platform may only allow voice commands by authorized users and, in some embodiments, a VR platform may provide voice control via an HMD or VR system that is not internet- or network-connected.

In some embodiments, a VR therapy platform may facilitate voice commands in a VR platform, e.g., for voice inputs from separate voice sources. For example, a VR platform, comprising a plurality of VR activities, may receive, via a microphone, a first audio input from a patient, determine a first request from the first audio input, select a first activity of the plurality of VR activities based on the determined first request, and provide the selected first activity of the plurality of VR activities. In some embodiments, the VR platform may receive, via the microphone, a second audio input from a supervisor, different from the patient, determine a second request from the second audio input, select a second activity of the plurality of VR activities based on the determined second request, and provide the selected second activity of the plurality of VR activities. In some embodiments, determining the first request from the first audio input may comprise determining a text-based request, and the selecting a first activity of the plurality of VR activities based on the determined first request further comprises selecting based on matching one or more keywords associated with the plurality of VR activities by with the text-based request. The microphone may be mounted, e.g., on a head-mounted display (HMD) worn by the patient.

In some embodiments, a VR therapy platform may provide a method of performing voice commands in a VR platform for a voice input, e.g., that may be authorized. For example, the VR platform may provide a VR platform with a plurality of VR activities, receive audio input, determine a request from the audio input, select one of the plurality of VR activities based on the determined request, and provide the selected one of the plurality of VR activities. In some embodiments, the determining a request from the audio input may further comprise determining an entity that provided the received audio input, determining whether the determined entity is authorized to provide audio input, in response to determining the determined entity is authorized to provide audio input, determining the request, and in response to determining the determined entity is not authorized to provide audio input, not determining the request. In some embodiments, the determining whether the determined entity is authorized to provide audio input may comprise accessing a voice authorization policy and determining whether the determined entity is authorized to provide audio input based on the accessed voice authorization policy.

In some embodiments, a VR system may comprise a microphone configured to receive an audio input, a HMD, and a processor. The processor may be configured to provide, via the HMD, the VR platform, determine a text-based request from the audio input, access a plurality of VR activities, each of the plurality of VR activities associated with one or more keywords, compare the text-based request with the one or more keywords associated with the plurality of VR activities, select a VR activity from the plurality of VR activities based on the comparing the text-based request with the one or more keywords associated with the plurality of VR activities, and provide the selected VR activity from the plurality of VR activities.

In some embodiments, a VR system may be configured to operate in an online mode and/or an offline mode. For instance, in an offline mode, the VR system may not be commented to a network and/or the internet. In some embodiments, a VR system may or may not be connected to a network server and/or cloud server for, e.g., voice processing. For example, in remote areas or treatment rooms unable to connect to the internet (e.g., limited or no Wi-Fi, 4G/5G/LTE, or other wired or wireless connection), a processor (e.g., on board the HMD) may provide all voice processing services. VR systems able to perform voice commands in an offline mode, e.g., without a network connection, may allow more portability for VR therapies, greater patient reach, and further aid in engagement and follow-through for therapy patients. In some embodiments, an offline mode (and online mode) may be dictated by network availability, or the lack of a network or internet connection. In some embodiments, an offline mode (and online mode) may be enabled with a toggle.

Various systems and methods disclosed herein are described in the context of a VR therapeutic system for helping patients, but the examples discussed are illustrative only and not exhaustive. A VR system as described in this disclosure may also be suitable for coaching, training, teaching, and other activities. Such systems and methods disclosed herein may apply to various and many VR applications. Such systems and methods disclosed herein may apply to various VR applications. Moreover, embodiments of the present disclosure may be suitable for augmented reality, mixed reality, and assisted reality systems. In some embodiments, a VR platform may comprise one or more VR applications. In some embodiments, a VR platform may comprise one or more speech recognition system and/or language processing applications.

In context of the VR voice control system, the word “patient” may generally be considered equivalent to a subject, user, participant, student, etc., and the term “therapist” may generally be considered equivalent to doctor, psychiatrist, psychologist, physical therapist, clinician, coach, teacher, social worker, supervisor, or any non-participating operator of the system. A real-world therapist may configure and/or monitor via a clinician tablet, which may be considered equivalent to a personal computer, laptop, mobile device, gaming system, or display.

Some embodiments may include a digital hardware and software medical device that uses VR for health care, focusing on mental, physical, and neurological rehabilitation; including various biometric sensors, such as sensors to measure and record heart rate, respiration, temperature, perspiration, voice/speech (e.g., tone, intensity, pitch, etc.), eye movements, facial movements, jaw movements, hand and feet movements, neural and brain activities, etc. The VR device may be used in a clinical environment under the supervision of a medical professional trained in rehabilitation therapy. In some embodiments, the VR device may be configured for personal use at home. In some embodiments, the VR device may be configured for remote monitoring. A therapist or supervisor, if needed, may monitor the experience in the same room or remotely. In some cases, a therapist may be physically remote or in the same room as the patient. Some embodiments may require someone, e.g., a nurse or family member, assisting the patient to place or mount the sensors and headset and/or observe for safety. Generally, the systems are portable and may be readily stored and carried.

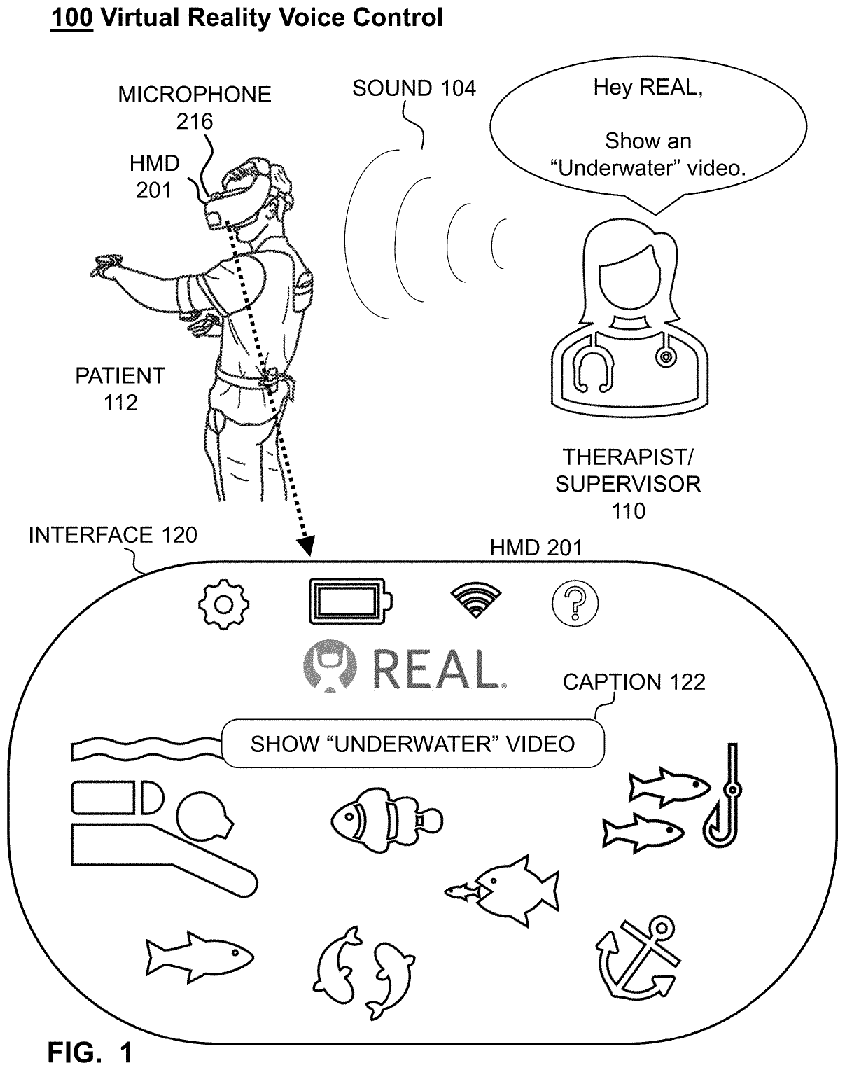

FIG. 1 depicts an illustrative scenario and interface of a VR voice control system, in accordance with embodiments of the present disclosure. For instance, scenario 100 depicts therapist 110 providing a command via sound 104, e.g., “Hey REAL, Show an ‘Underwater’ video,” to microphone 216 on HMD 201 worn by patient 112. As a result of receiving sound 104, interface 120 displayed in HMD 201 provides an “Underwater” video, for patient 112, along with caption 122, “show ‘Underwater’ video.”

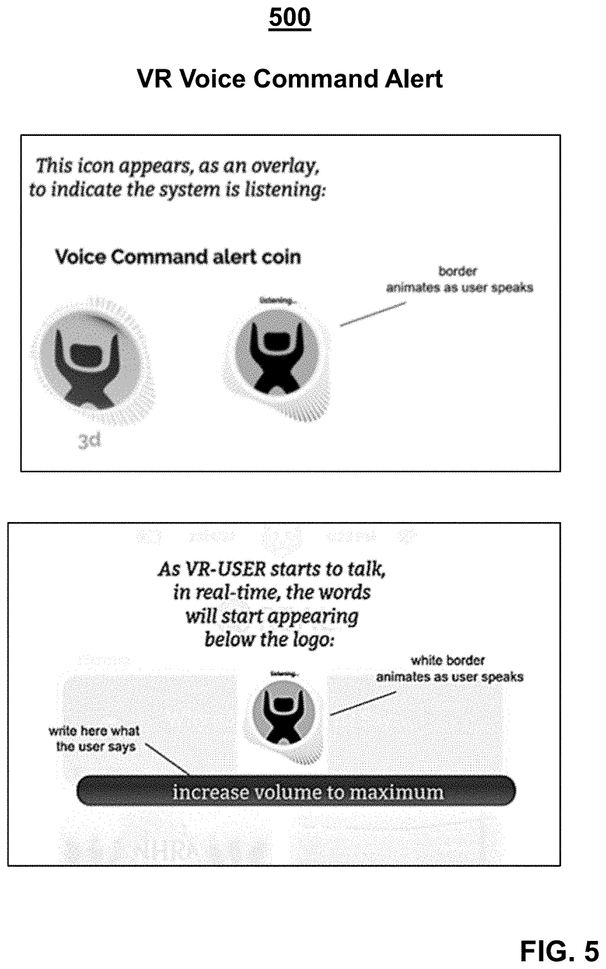

In some embodiments, such as scenario 100, voice commands may be requested by patient 112 (e.g., a user) and/or therapist 110 (e.g., a therapist, supervisor, or other observer). In some embodiments, accepting commands from an experienced therapist/supervisor may be more efficient, easier, and/or safer than relying on a patient to issue commands. Generally, microphone 216 on HMD 201 may receive sound 104 comprising a voice command. The VR platform may identify a requested activity in sound 104 and cause the corresponding VR activity, e.g., an ‘Underwater’ video, to be provided in interface 120. Interface 120, in some embodiments, may incorporate menus and/or user interface elements to allow a patient to access one or more activities, applications, and exercises. A VR platform may have dozens—if not hundreds or thousands—of selectable activities, exercises, videos, multimedia experiences, applications, and other content (generally, “activities”). Accessing a particular activity directly, rather than scrolling or inputting text for a search, can save time and effort, as well as increase safety. In some embodiments, a VR interface may include a voice interface or, e.g., cooperate with a voice interface, voice assistant, or voice command application. In some embodiments, an interface may display an icon to indicate the system is listening and/or waiting for a command, e.g., as depicted in FIG. 5.

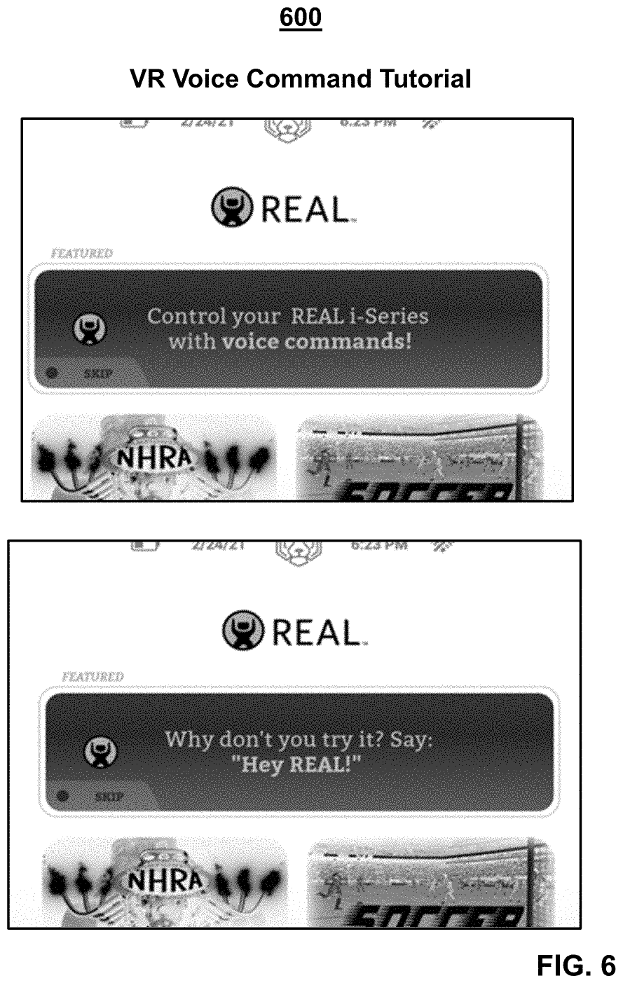

In some embodiments, a voice command may comprise a request of the voice assistant, a request for the VR platform, and/or a request to commence an activity. In some embodiments, audio input may comprise a wake word to, e.g., trigger the voice assistant. In scenario 100, the wake word is “Hey REAL.” In some embodiments, an interface may display or otherwise suggest potential voice commands for use with the VR platform, e.g., as depicted in FIGS. 6-8.

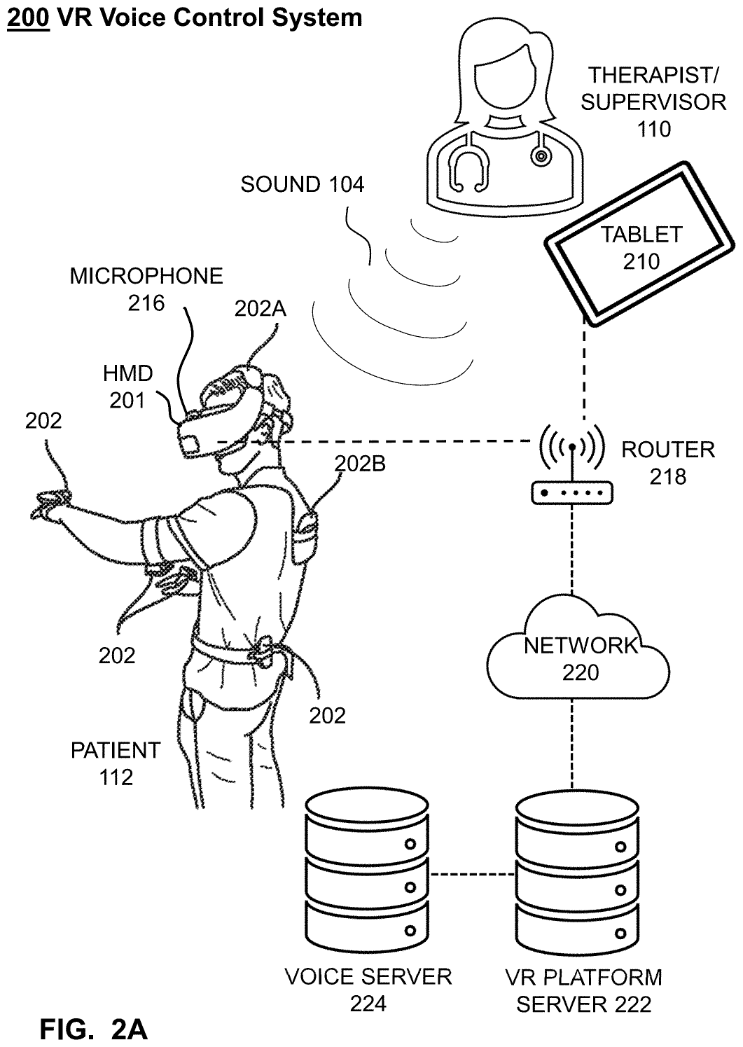

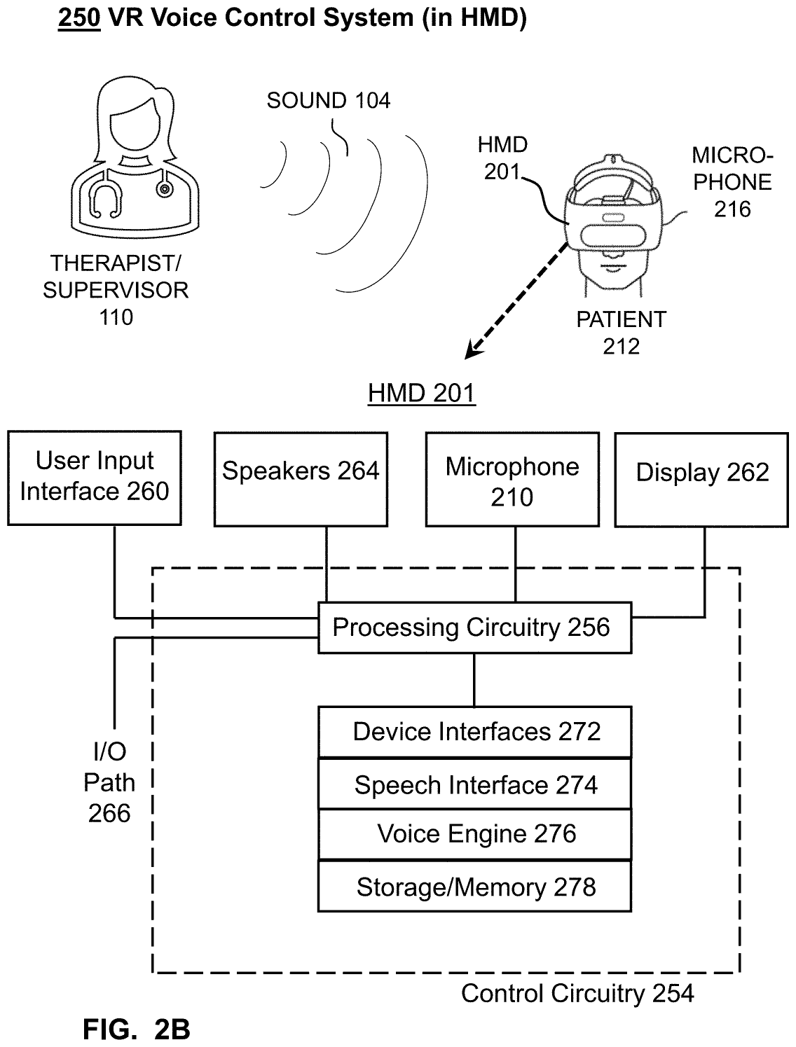

Processing a voice command in sound 104 may be carried out in numerous ways. In some embodiments, processing sound 104 as, e.g., a voice command, may use automatic speech recognition and/or natural language processing. In some embodiments, processing may include a search of the available activities based on recognized speech. In some embodiments, processing sound 104 may comprise steps such as: converting the received audio to input text, looking up each converted word (or phrase) in a vocabulary database, and identifying words in vocabulary database in the input text. In some embodiments, a vocabulary database may be stored with storage or memory of the VR system, e.g., memory in the HMD as depicted in FIG. 2B. In some embodiments, a vocabulary database may be stored in storage or memory on a remote server, e.g., in the cloud as depicted in FIG. 2A. In some embodiments, portions of a vocabulary database may be stored locally and/or remotely. In some embodiments, a VR voice engine may parse converted input text into phrases to be recognized. For instance, phrases and words like “take me,” “show me,” or “let's play” may be readily recognized in a vocabulary database as introductions for commands to, e.g., “Take me to [name of a city or a place],” “Show me videos of [anything],” or “Let's play [a game].”

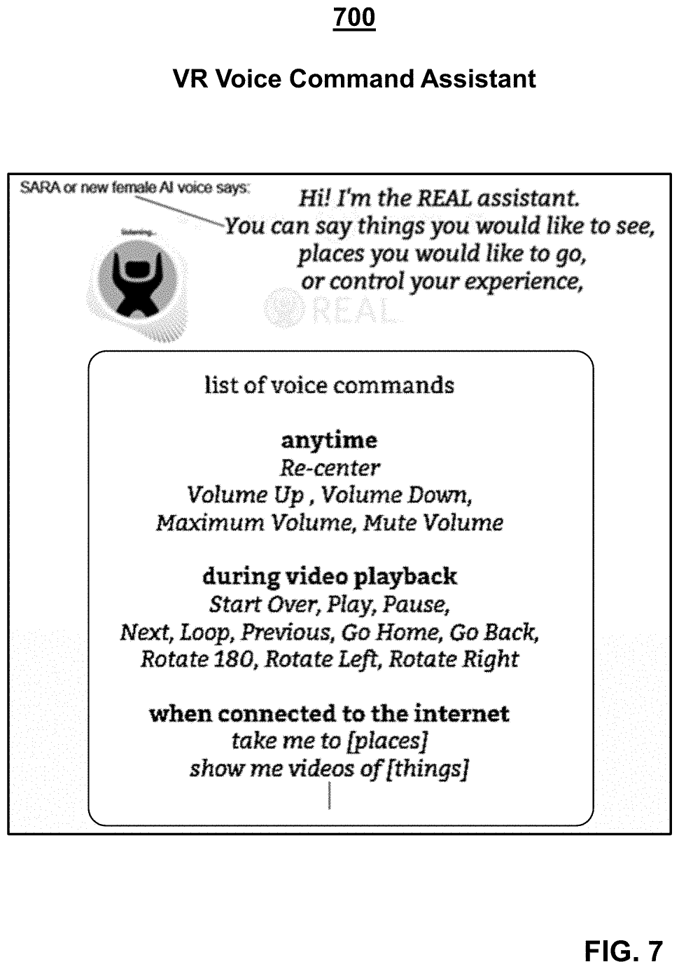

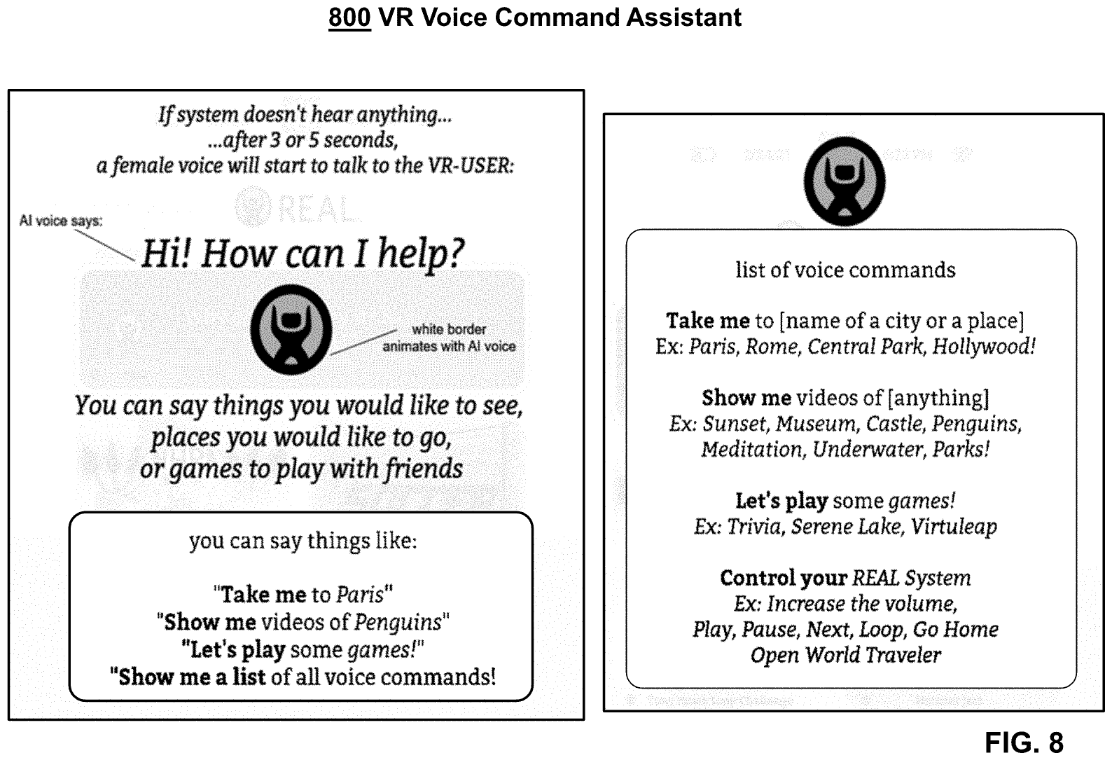

In some embodiments, potential words coming after an introduction of a command may also be stored in a vocabulary database as, e.g., activities and interface commands. For instance, a list of keywords describing available activities may be stored in a vocabulary database. In some cases, such keywords may be developed based on metadata of each of the available activities. During processing of audio input that is, e.g., converted to input text, a keyword describing an available activity and/or content item may be recognized. In some embodiments, voice commands, such as those depicted in FIGS. 7-8, may be incorporated in a vocabulary database.

In some embodiments, a voice command in sound 104 may trigger a search by a voice engine and search results, e.g., an activity or command that best matches, returned. For instance, with a voice request such as “Show me Paris,” a voice engine may convert the audio to text, e.g., using automated speech recognition, and provide a top-ranked result matching keyword “Paris” from the activity library. In some embodiments, VR voice commands in sound 104 may be more complicated and may be parsed as phrases and/or keywords. In some embodiments, a finite number of activities, e.g., in the activity library stored in the HMD's memory (or in a remote cloud server) may allow for efficient keyword matching. In some embodiments, a VR platform and/or voice engine may utilize a VR voice assistant to initiate some or all activities, as well as facilitate commands (e.g., trick play commands) such as the commands depicted in FIGS. 7 and 8.

Once sound 104 is converted and words and/or phrases are recognized, the VR platform may provide a corresponding activity or content, e.g., based on sound 104. In some embodiments, one or more keywords identified in the text converted from the voice input may be cross-referenced in the vocabulary database and a corresponding activity may be provided, e.g., from an activity library. In some embodiments, processing may include a search of the available activities based on recognized speech and, e.g., search results of the best match (or top matches).

In some embodiments, such as scenario 100, accepting commands from an experienced supervisor may be more efficient, easier, and/or safer than relying on a patient to issue commands, e.g., read on-screen and/or heard from the therapist. For instance, a therapist may require a patient to participate in a particular, appropriate activity without losing too much time or focus. In some embodiments, sound 104, e.g., in the form of a voice command, may be received from patient 112 and/or therapist 110. In some embodiments, microphone 216 may be sensitive enough to accept input from an observer, bystander, or supervisor. In some embodiments, microphone 216 may be multiple microphones, e.g., an array of microphones. In some embodiments, the VR voice engine may use multiple audio inputs, e.g., to triangulate a location of the voice. In some embodiments, distance may be inferred based on intensity of the received input audio. In some embodiments, a therapist may have her own microphone, e.g., connected wirelessly via radio or Bluetooth, and distance from the patient may be determined.

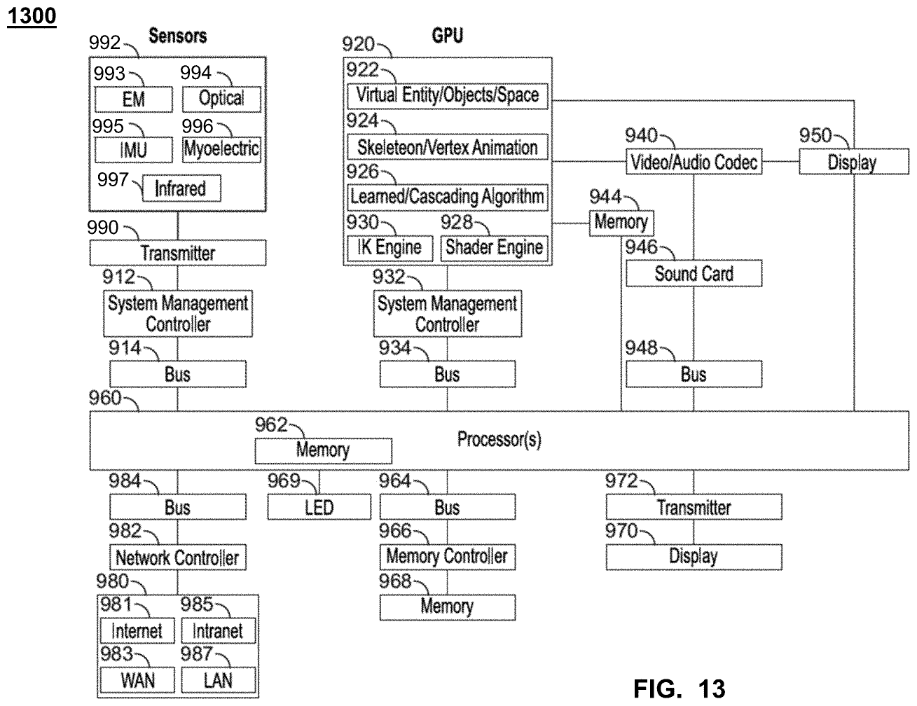

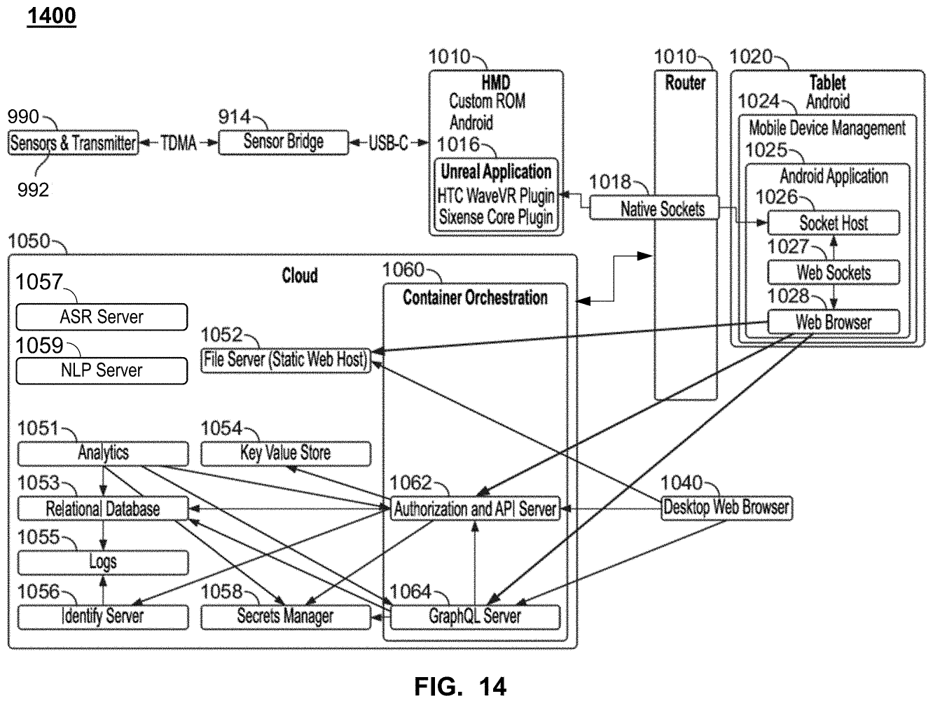

FIG. 2A depicts an illustrative VR voice control system, in accordance with embodiments of the present disclosure. For instance, scenario 200 depicts therapist 110 providing a command via sound 104 to microphone 216 on HMD 201 worn by patient 112. Scenario 200 depicts HMD 201 and a supervisor tablet 216 in wireless communication with router 218, which is connected to network 220 (e.g., via the internet) and connected to VR platform server 222 and voice server 224. In some embodiments, voice server 224 may process sound 104 using, e.g., automatic speech recognition and/or natural language processing. In some embodiments, VR platform server 222 may coordinate with HMD 201 to provide the VR platform and activities. For instance, a VR platform server 222 may be incorporated in one or more of the systems of FIGS. 13-14. Scenario 200 also depicts sensors 202 and transmitter module 202B, which may be used as input for a VR activity and/or interface. In some embodiments, additional inputs such as controllers, cameras, biometric devices, and other sensors may be incorporated.

In some embodiments, a network connection may not be available and voice command processing must be done locally, e.g., by the HMD. This may allow VR therapy in places with weak or no internet connections. FIG. 2B depicts an illustrative VR voice control system, in accordance with embodiments of the present disclosure. For instance, scenario 250 depicts therapist 110 providing a command via sound 104 to microphone 216 on HMD 201 worn by patient 112. Scenario 250 depicts HMD 201 operating without wireless communication (e.g., no connection to an outside network and/or the internet). In some embodiments, such as scenario 250, HMD 201 may process audio voice commands without accessing an outside voice server. For instance, HMD 201 may process sound 104 using, e.g., automatic speech recognition and/or natural language processing. In some embodiments, such as scenario 250, HMD 201 may provide the VR platform and activities without accessing a server.

FIG. 2B also shows a generalized embodiment of an illustrative user equipment device 201 that may serve as a computing device. User equipment device 201 may receive content and data via input/output (hereinafter “I/O”) path 262. I/O path 262 may provide content (e.g., broadcast programming, on-demand programming, Internet content, content available over a local area network (LAN) or wide area network (WAN), and/or other content) and data to control circuitry 254, which includes processing circuitry 256 and storage 278. Control circuitry 254 may be used to send and receive commands, requests, and other suitable data using I/O path 262. I/O path 262 may connect control circuitry 254 (and specifically processing circuitry 256) to one or more communications paths (described below). I/O functions may be provided by one or more of these communications paths but are shown as a single path to avoid overcomplicating the drawing.

Control circuitry 254 may be based on any suitable processing circuitry such as processing circuitry 256. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 254 executes instructions for receiving streamed content and executing its display, such as executing application programs that provide interfaces for content providers to stream and display content on display 312.

Some embodiments, as depicted in scenario 250 of FIG. 2B, may feature a VR system capable of providing voice services in an online mode and/or an offline mode. Control circuitry 254 may include communications circuitry suitable for communicating with a VR platform and/or cloud content provider if and/or when a connection is available, e.g., in an online mode. Some embodiments include an online and/or offline mode, e.g., where an offline mode does not rely on voice processing by cloud and/or network services, and the communications circuitry may not be connected to a network. In some embodiments, network communications may be limited, and communications circuitry may not be necessary components for a VR system able to perform in an offline mode. For instance, VR systems may be configured without network connections or for use in areas without wireless connections. In some embodiments, storage/memory 278 may comprise all available VR activities in an activity library. In some embodiments, communications circuitry may comprise one or more ports, e.g., a USB connection, for enabling periodic system updates and patches during temporary connections.

Memory may be an electronic storage device provided as storage/memory 278 that is part of control circuitry 254. As referred to herein, “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 278 may be used to store various types of content described herein as well as interface application described above. Nonvolatile memory may also be used (e.g., to launch a boot-up routine and other instructions).

Storage 278 may also store instructions or code for an operating system and any number of application programs to be executed by the operating system. In operation, processing circuitry 256 retrieves and executes the instructions stored in storage 278, to run both the operating system and any application programs started by the user. The application programs can include a VR application, as well as a voice interface application for implementing voice communication with a user, and/or content display applications which implement an interface allowing users to select and display content on display 312 or another display.

Control circuitry 254 may include video generating circuitry and tuning circuitry, such as one or more analog tuners, one or more MPEG-2 decoders or other digital decoding circuitry, high-definition tuners, or any other suitable tuning or video circuits or combinations of such circuits.

A user (e.g., a patient) may send instructions to control circuitry 254 using user input interface 260. User input interface 260 may be any suitable user interface, such as a remote control, mouse, trackball, keypad, keyboard, touch screen, touchpad, stylus input, joystick, voice recognition interface, or other user input interfaces. Display 312 may be provided as part of HMD 201 but may also feature a separate stand-alone device. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 254. The video card may be integrated with the control circuitry 254. Speakers 264, connected via a sound card, may be provided as integrated with other elements of user equipment device 201 or may be stand-alone units. The audio component of videos and other content displayed on display 312 may be played through speakers 264. In some embodiments, the audio may be distributed to a receiver (not shown), which processes and outputs the audio via speakers 264. Audio may be captured by microphone 216, which may be connected via a sound card as well.

When an internet connection is available, HMD 201 may receive content and data via I/O paths 266. I/O path 262 may provide content and data for content consumption. I/O path 266 may provide data to, and receive content from, one or more content providers. HMD 201 has control circuitry 254 which includes processing circuitry 256 and storage 278. The control circuitry 254, processing circuitry 256, and storage 278 may be constructed, and may operate, in similar manner to the respective components of user equipment device 201.

HMD 201 may serve as a voice processing server. Storage 278 is a memory that stores a number of programs for execution by processing circuitry 256. In particular, storage 278 may store a number of device interfaces 272, a speech interface 274, voice engine 276 for processing voice inputs via device 200 and selecting voice profiles therefrom, and storage 278. The device interfaces 272 are interface programs for handling the exchange of commands and data with the various devices. Speech interface 274 is an interface program for handling the exchange of commands with and transmission of voice inputs to various components. Speech interface 274 may convert speech to text for processing. Voice engine 276 includes code for executing all of the above-described functions for processing voice commands, authorizing voice inputs, and sending one or more portions of a voice input to speech interface 274. Storage 278 is memory available for any application and is available for storage of terms or other data retrieved from device 200, such as voice profiles, or the like.

In some embodiments, HMD 201 may be any electronic device capable of electronic communication with other devices and accepting voice inputs. For example, device 201 may be a laptop computer or desktop computer configured as above. In Scenario 250, device 201 is not connected to an outside network or the internet, and processes voice commands without interacting with an outside server.

Processing a voice command in sound 104 may be carried out in numerous ways, e.g., without relying on a cloud server. Generally, microphone 216 on HMD 201 may receive sound 104 comprising a voice command. In scenario 250, voice engine 276 of HMD 201 may identify a requested activity in sound 104 and processing circuitry 256 may cause the corresponding VR activity to be provided via display 262. In some embodiments, such as scenario 250, processing voice input as, e.g., a voice command, may use automatic speech recognition and/or natural language processing performed solely by HMD 201. In some embodiments, processing may include a search of the available activities based on recognized speech performed solely by HMD 201. In some embodiments, processing a voice command may comprise steps, performed solely by HMD 201, such as: converting the received audio to input text, looking up each converted word (or phrase) in a vocabulary database, and identifying words in vocabulary database in the input text. In some embodiments, a vocabulary database may be stored with storage or memory of the VR system, e.g., memory in the HMD. In some embodiments, a VR voice engine may parse converted input text into phrases to be recognized, performed solely by HMD 201. For instance, phrases and words like “take me,” “show me,” or “let's play” may be readily recognized by HMD 201 in a vocabulary database, stored in memory of HMD 201, as introductions for commands to, e.g., “Take me to [name of a city or a place],” “Show me videos of [anything],” or “Let's play [a game].” In some embodiments, potential words coming after an introduction of a command may also be stored in a vocabulary database as, e.g., activities and interface commands. During processing of audio input by HMD 201, in scenario 250, a keyword describing an available activity and/or content item may be recognized. In some embodiments, voice commands, such as those depicted in FIGS. 7-8, may be incorporated in a vocabulary database stored in memory of HMD 201.

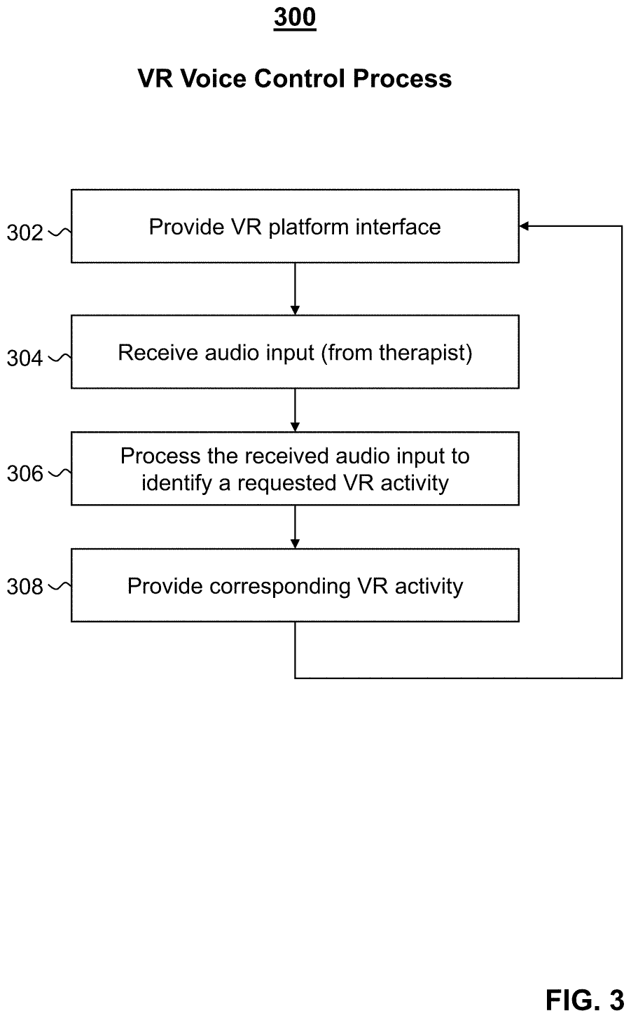

FIG. 3 illustrates a flow chart for an exemplary VR voice control, in accordance with embodiments of the present disclosure. There are many ways to enable voice control within a VR platform, e.g., during VR therapy, and process 300 is one example. Some embodiments may utilize a VR voice engine to perform one or more parts of process 300, e.g., as part of a VR application, stored and executed by one or more of the processors and memory of a headset, server, tablet and/or other device. For instance, a VR voice engine may be incorporated in, e.g., as one or more components of, head-mounted display 201 and/or other systems of FIGS. 2A-2B and 11A-14. In some embodiments, a VR voice engine may be a component of a VR platform or a VR application.

Voice commands may be requested by the patient (e.g., a user) or a therapist (e.g., a therapist, supervisor, or other observer). Generally, a VR platform and/or voice engine may receive a voice command, identify a requested VR activity in the voice command, and cause the corresponding VR activity to be provided. In some cases, a voice command may trigger a search by a voice engine and search results, e.g., an activity or command that best matches, returned. For instance, with a voice request such as “Show me Paris,” a voice engine may convert the audio to text, e.g., using automated speech recognition, and provide a top-ranked result matching keyword “Paris” from the activity library. In some embodiments, VR voice commands could be more complicated but may be parsed as phrases and/or keywords. In some embodiments, a finite number of activities, e.g., in the activity library stored in the HMD's memory (or in a remote cloud server) may allow for efficient keyword matching. In some embodiments, a VR platform and/or voice engine may utilize a VR voice assistant to initiate some or all activities, as well as facilitate commands (e.g., trick play commands) such as the commands depicted in FIGS. 7 and 8.

Process 300 may begin at step 302. At step 302, a VR platform interface may be provided. In some embodiments, an interface may include a display. For instance, a VR platform may provide an interface such as interface 120 depicted in FIG. 1. An interface, in some embodiments, may incorporate menus and/or user interface elements to allow a patient to access one or more activities, applications, and exercises. In some embodiments, a VR interface may include a voice interface or, e.g., function with a voice interface, voice assistant, or voice command application. In some embodiments, an interface may display or otherwise suggest potential voice commands for use with the VR platform.

At step 304, a VR voice engine receives audio input. In some embodiments, audio input, e.g., in the form of a voice command, may be received from the patient and/or the therapist. In some embodiments, a microphone may be sensitive enough to accept input from a bystander or supervisor. As disclosed herein, accepting commands from an experienced supervisor may be more efficient, easier, and/or safer than relying on a patient to issue commands, e.g., read on-screen and/or heard from the therapist. For instance, a therapist may require a patient to participate in a particular, appropriate activity without losing too much time or focus.

Generally, a voice command may comprise a request of the voice assistant, a request for the VR platform, and/or a request to commence an activity, exercise, video, multimedia experience, application, and other content (together referred to as “activities”). In some embodiments, audio input may comprise a wake word to, e.g., trigger the voice assistant.

At step 306, a VR voice engine processes the audio input to identify requested VR activity. In some embodiments, processing audio input as, e.g., a voice command, may use automatic speech recognition and/or natural language processing. In some embodiments, processing may include a search of the available activities based on recognized speech. In some embodiments, processing audio input may comprise steps such as: converting the received audio to input text, looking up each converted word (or phrase) in a vocabulary database, and identifying words in vocabulary database in the input text. In some embodiments, a vocabulary database may be stored with storage or memory of the VR system, e.g., memory in the HMD as depicted in FIG. 2B. In some embodiments, a vocabulary database may be stored in storage or memory on a remote server, e.g., in the cloud as depicted in FIG. 2A. In some embodiments, a VR voice engine may parse converted input text into phrases to be recognized. For instance, phrases and words like “take me,” “show me,” or “let's play” may be readily recognized in a vocabulary database as introductions for commands to, e.g., “Take me to [name of a city or a place],” “Show me videos of [anything],” or “Let's play [a game].” During processing of audio input that is, e.g., converted to input text, a keyword describing an available activity and/or content item may be recognized. In some embodiments, voice commands, such as those depicted in FIGS. 7-8, may be incorporated in a vocabulary database. In some embodiments, a “wake word” may be recognized quickly in voice input, e.g., as part of a vocabulary database or separate.

At step 308, a VR platform and/or voice engine provides a corresponding activity or content, e.g., based on the received audio input. In some embodiments, one or more keywords identified in the text converted from the voice input may be cross-referenced in the vocabulary database and a corresponding activity may be provided, e.g., from an activity library. In some embodiments, processing may include a search of the available activities based on recognized speech and, e.g., search results of the best match (or top matches). After providing the VR activity, the process restarts at step 302, and the VR platform interface is provided.

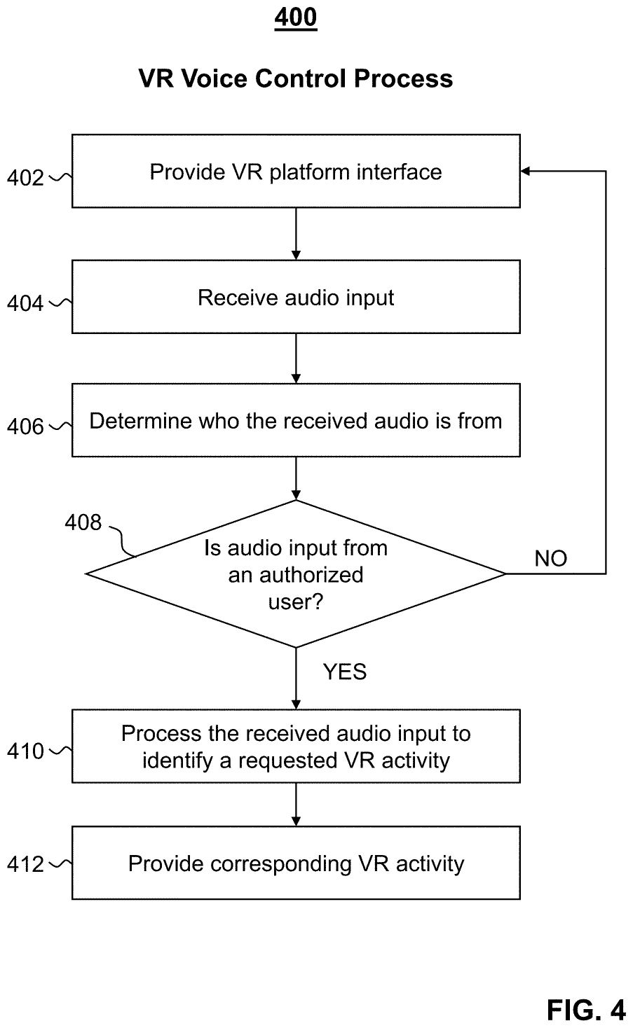

FIG. 4 illustrates a flow chart for an exemplary VR voice control, in accordance with embodiments of the present disclosure. There are many ways to enable voice control within a VR platform, e.g., during VR therapy, and process 400 is one example. Some embodiments may utilize a VR voice engine to perform one or more parts of process 400, e.g., as part of a VR application, stored and executed by one or more of the processors and memory of a headset, server, tablet and/or other device. For instance, a VR voice engine may be incorporated in, e.g., as one or more components of, head-mounted display 201 and/or other systems of FIGS. 2A-2B and 11A-14. In some embodiments, a VR voice engine may be a component of a VR platform or a VR application. Generally, a VR platform and/or voice engine may receive a voice command, determine if the voice command is from an authorized user, identify a requested VR activity in the voice command if authorized, and cause the corresponding VR activity to be provided.

Process 400 may begin at step 402. At step 402, a VR platform interface may be provided. In some embodiments, an interface may include a display. For instance, a VR platform may provide an interface such as interface 120 depicted in FIG. 1. An interface, in some embodiments, may incorporate menus and/or user interface elements to allow a patient to access one ore more activities, applications, and exercises. In some embodiments, a VR interface may include a voice interface or, e.g., function with a voice interface, voice assistant, or voice command application. In some embodiments, an interface may display or otherwise suggest potential voice commands for use with the VR platform.

At step 404, a VR voice engine receives audio input. In some embodiments, audio input, e.g., in the form of a voice command, may be received from the patient and/or the therapist. In some embodiments, a bystander may provide (unauthorized) audio input. For instance, a spectator unauthorized to participate, such as a patient's family member who may be present in the room for silent support, could inadvertently provide a voice input. In some embodiments, a microphone may be sensitive enough to accept input from a bystander or supervisor. As disclosed herein, accepting commands from an authorized supervisor, and not a patient or bystander, may allow for more efficient, easier, and/or safer activities. For instance, a bystander may not request an appropriate activity that is needed by a therapist and/or desired by a patient. In some cases, a patient may request inappropriate activities, e.g., due to age and/or impairment, and may not have authorization for voice commands or may have authorization revoked.

At step 406, the VR voice engine determines from whom the audio input is received— e.g., the speaker. In some embodiments, the VR voice engine identifies the person who provided the audio input. For instance, the VR voice engine may match the voice to a particular voice profile and/or a set of predetermined voice profiles based on audio characteristics of the voice (e.g., pitch, tone, intensity, pronunciation, etc.). In some embodiments, the VR voice engine identifies the location, e.g., based on amplitude and/or direction for the received audio input. In some embodiments, the VR voice engine may use multiple audio inputs like a microphone array, e.g., to triangulate a location of the voice. In some embodiments, the VR voice engine may utilize ASP/NLP and match speech characteristics to a user profile in order to identify the speaker. In some embodiments, the VR voice engine identifies the received audio input.

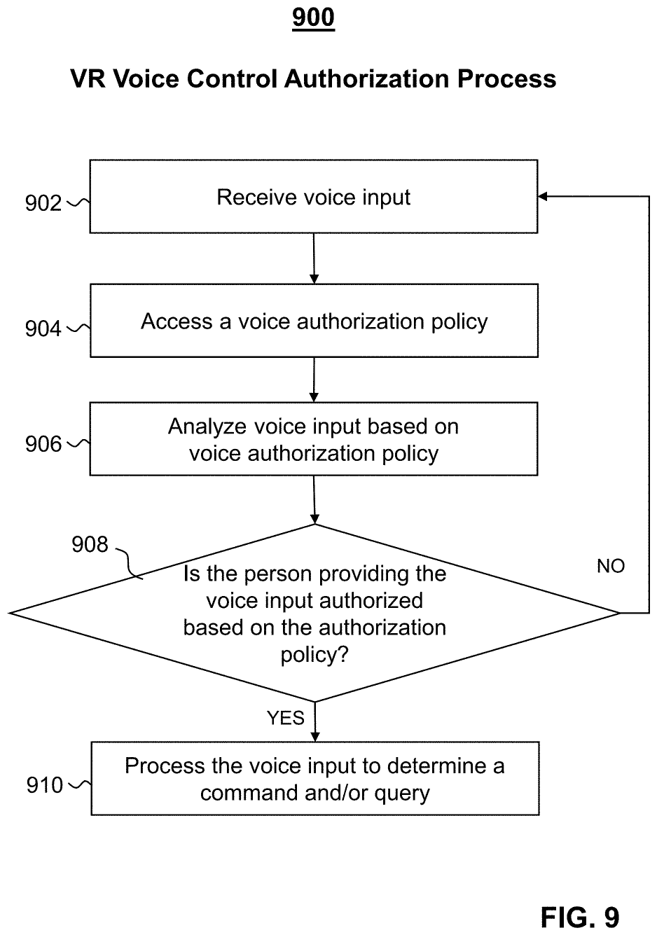

At step 408, the VR voice engine determines whether the received audio input is from an authorized user. For instance, the VR voice engine determines whether the received audio input is from an authorized person such as the therapist or the patient, as opposed to an observer or a bystander. In some embodiments, the VR voice engine may only authorize the patient and therapist. In some embodiments, the VR system may access user profiles and/or appointment data to identify which patient and/or therapist may be authorized. In some embodiments, the VR voice engine may only authorize the therapist. For instance, a patient who is a child or has a mental impairment may not be authorized to give voice commands. Process 900 of FIG. 9 describes an exemplary voice authorization process.

If at step 408, the VR voice engine determined the received audio input was not from an authorized user, then, the audio input is ignored and the process restarts at step 402, with the VR platform interface being provided.

If at step 408, the VR voice engine determined the received audio input was from an authorized user, then, at step 410, a VR voice engine processes the audio input to identify requested VR activity. In some embodiments, processing audio input as, e.g., a voice command, may use automatic speech recognition and/or natural language processing. In some embodiments, processing may include a search of the available activities based on recognized speech. In some embodiments, processing audio input may comprise steps such as: converting the received audio to input text, looking up each converted word (or phrase) in a vocabulary database, and identifying words in vocabulary database in the input text. In some embodiments, portions of a vocabulary database may be stored locally and/or remotely. In some embodiments, a VR voice engine may parse converted input text into phrases to be recognized. In some embodiments, potential words coming after an introduction of a command may also be stored in a vocabulary database as, e.g., activities and interface commands. For instance, a list of keywords describing available activities may be stored in a vocabulary database. During processing of audio input, a keyword describing an available activity and/or content item may be recognized.

At step 412, a VR platform and/or voice engine provides a corresponding activity or content, e.g., based on the received audio input. In some embodiments, one or more keywords identified in the text converted from the voice input may be cross-referenced in the vocabulary database and a corresponding activity may be provided. In some embodiments, processing may include a search of the available activities based on recognized speech. After providing the VR activity, the process restarts at step 402, and the VR platform interface is provided.

FIG. 5 depicts illustrative VR voice control system interfaces, in accordance with embodiments of the present disclosure. More specifically, scenario 500 of FIG. 5 depicts a VR voice command alert that shows an animated icon when, e.g., the VR platform is listening. Listening may occur after a wake word and/or after interaction with a user interface element such as a button or icon. Scenario 500 of FIG. 5 further depicts text of words recognized by the voice engine, e.g., “increase volume to maximum.”

FIG. 6 depicts illustrative VR voice control tutorial interfaces, in accordance with embodiments of the present disclosure. More specifically, scenario 600 of FIG. 6 depicts a VR voice command tutorial that shows an introduction to the voice command interface and instructs how to access the voice command system using a “wake word” like “Hey REAL!”

FIG. 7 depicts illustrative VR voice control system interfaces, in accordance with embodiments of the present disclosure. More specifically, scenario 700 of FIG. 7 depicts a VR voice command assistant notification with a list of voice commands, such as, “Re-center,” “Volume Up,” “Volume Down,” . . . “Play,” “Pause,” . . . “Rotate Left,” . . . “take me to [places],” and “show me videos of [things].”

FIG. 8 depicts illustrative VR voice control system interfaces, in accordance with embodiments of the present disclosure. More specifically, scenario 800 of FIG. 8 depicts a VR voice command assistant notification with a list of voice commands, such as, “Take me to [name of a city or a place],” “Show me videos of [anything],” or “Let's play [a game].”

FIG. 9 depicts an illustrative flow chart of a VR voice control process, in accordance with embodiments of the present disclosure. There are many ways to authorize voice commands within a VR platform, e.g., during VR therapy, and process 900 is one example. Some embodiments may utilize a VR voice engine to perform one or more parts of process 900, e.g., as part of a VR application, stored and executed by one or more of the processors and memory of a headset, server, tablet and/or other device. For instance, a VR voice engine may be incorporated in, e.g., as one or more components of, head-mounted display 201 and/or other systems of FIGS. 2A-2B and 11A-14. In some embodiments, a VR voice engine may be a component of a VR platform or a VR application. Generally, a VR platform and/or voice engine may receive a voice input, access a voice authorization policy, analyze the voice input based on the voice authorization policy, determine whether the person providing the voice input is authorized to make a request, and process the voice command if authorized.

Process 900 may begin at step 902. At step 902, a VR voice engine receives a voice input. In some embodiments, voice input may be in the form of a voice command and may be received from the patient and/or the therapist. In some embodiments, a microphone may be sensitive enough to accept input from a bystander or supervisor. As disclosed herein, accepting commands from an experienced supervisor may be more efficient, easier, and/or safer than relying on a patient to issue commands, e.g., read on-screen and/or heard from the therapist. For instance, a therapist may require a patient to participate in a particular, appropriate activity without losing too much time or focus.

At step 904, the VR voice engine accesses at least one voice authorization policy. A voice authorization policy may be, e.g., a rule or policy governing who is authorized to provide voice commands and/or from whom the voice engine may accept voice commands. For instance, each of a patient and a therapist (or a plurality of patients and therapists) may have a use profile with associated credentials and authorization level. A therapist or patient may have a user profile, e.g., via login, biometric authentication, and/or voice authentication, that is stored with user profile data.

In many cases, bystanders or spectators who do not have a profile with the VR platform would not be authorized for voice commands, e.g., as they may interrupt therapy. For instance, a bystander may be a family member who came with the patient for help and support, however, that family member may not be permitted to use voice commands. A child brought along because there of childcare conflicts may not have authorization for voice commands. In some embodiments, authorization may be a distance from the microphone(s). For instance, the VR voice engine may identify the location, e.g., based on amplitude and/or direction for the received audio input. Bystanders may be determined to be outside of a threshold distance, e.g., a 3-meter radius of the patient, and authorized users may be voice detected within such a threshold. In some embodiments, the VR voice engine may use multiple audio inputs, e.g., to triangulate a location of the voice. In some embodiments, distance may be inferred based on intensity of the received input audio. In some embodiments, a therapist may have her own microphone, e.g., connected wirelessly via radio or Bluetooth, and distance from the patient may be determined.

In some embodiments, any new voice (e.g., without a profile) may be unauthorized until given authorization. For instance, a therapist (or administrator) may create a profile for a new patient. In some embodiments, a profile may be developed by asking a user to read a specific phrase, e.g., to train the voice engine to recognize key sounds and/or words of a voice. In some embodiments, a secret passcode or PIN may be provided to a user to be spoken aloud for login, verification, and/or profile creation purposes. For instance, at the beginning of a session, a therapist may provide a PIN or passcode sentence via an HMD screen or text message to be read. This may allow profile login and authentication, as well as providing a voice sample for matching and authorization of voice commands.

In some embodiments, each patient may have a different level of authorization based on, e.g., age, experience, number of uses, hours of therapy, physical and/or mental capabilities, impairments, etc. For instance, a patient with Alzheimer's may not be permitted to make voice commands, but her therapist is allowed. In some cases, voice commands from a child patient may not be accepted and/or acted upon. For instance, a child patient may attempt to interrupt therapy to start a preferred video or activity, so authorization may not be given or may be revoked.

In some embodiments, standard profiles may be used, and voices may be roughly matched for each user. For instance, several voice profiles based on audio characteristics such as tone, intensity, frequency, pitch, cadence, pronunciation, accent, etc., may be used to approximate patient voices. One might use sample voice profiles to match, e.g., age ranges and genders, such as adult female, adult male, senior female, senior male, adolescent female, adolescent male, child female, child male, etc. In some embodiments, a patient may be assigned a similar profile at the beginning of a session, e.g., by reading a sentence, and authorized for voice commands thereafter. A bystander may not be assigned to one of the voice profiles and the system should differentiate the patient's voice (matching a standard profile) from a bystander based on audio characteristics, including proximity to the microphone.

At step 906, the VR voice engine analyzes voice input based on the voice authorization policy or policies. For instance, the voice engine may identify a voice and look up a corresponding voice authorization policy for the identified voice (or user profile). In some embodiments, the voice input may be analyzed in view of a voice authorization policy based on inferred distance from the microphone(s). For instance, voices within a certain distance of the microphone(s) may be authorized. In some embodiments, the voice input based on a voice authorization policy based on audio characteristics such as sound level, amplitude, intensity, pitch, frequency, amount of noise, signal-to-noise ratio, tone, etc.

At step 906, the VR voice engine determines whether the person providing the voice input authorized based on the authorization policy. For instance, once the authorization policy is accessed and the desired information about the voice input (e.g., identification, metrics, distance, etc.) is determined, then authorization may be determined. If the voice input fits the criteria of the authorization policy, then the process may proceed to step 910.

If at step 908, the VR voice engine determined the received audio input was not from an authorized user, then, the voice input is ignored and the process restarts at step 902, with the VR platform and voice engine waiting to receive a voice input.

If at step 908, the VR voice engine determined the received audio input was from an authorized user, then, at step 910, a VR voice engine processes the voice input to, e.g., identify a voice command, query, and/or requested VR activity. In some embodiments, processing audio input as, e.g., a voice command, may use automatic speech recognition and/or natural language processing. In some embodiments, processing may include a search of the available activities based on recognized keywords and phrases found in, e.g., a vocabulary database stored locally and/or remotely.

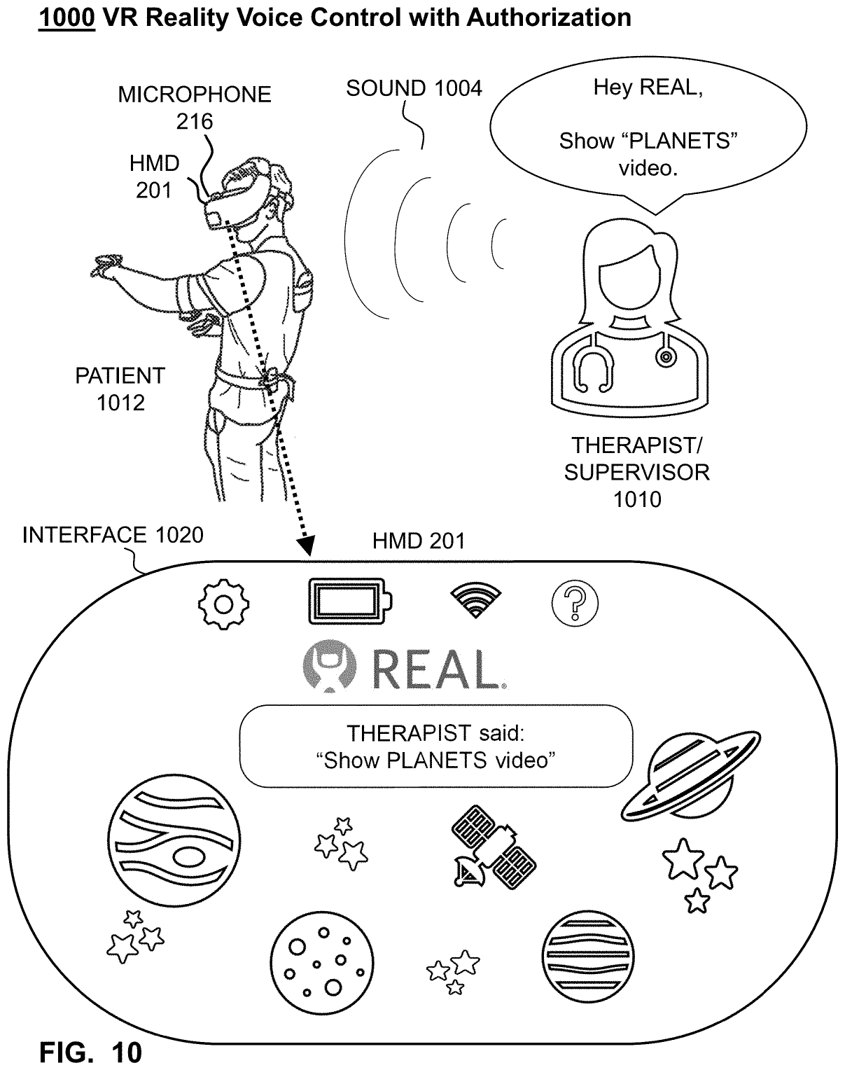

FIG. 10 depicts an illustrative scenario and interface of a VR voice control system, in accordance with embodiments of the present disclosure. More specifically, scenario 1000 of FIG. 10 depicts identification (and authorization) of a speaker using voice commands in a VR platform. For instance, scenario 1000 depicts therapist 1010 providing a command via sound 1004, e.g., “Hey REAL, Show ‘PLANETS’ video,” to microphone 216 on HMD 201 worn by patient 1012. As a result of receiving sound 1004, interface 1020 displayed in HMD 201 provides “PLANETS” video, for patient 1012, along with caption 122, “THERAPIST said: ‘show ‘PLANETS’ video.’” Identification of the “THERAPIST” in interface 1020 indicates that the provider of the voice command was identified and/or authorized.

In some embodiments, such as scenario 100, voice commands may be requested by patient 112 (e.g., a user) and/or therapist 110 (e.g., a therapist, supervisor, or other observer). In some embodiments, accepting commands from an experienced therapist/supervisor may be more efficient, easier, and/or safer than relying on a patient to issue commands. Generally, microphone 216 on HMD 201 may receive sound 1004 comprising a voice command. The VR platform may identify a requested activity in sound 1004 and cause the corresponding VR activity, e.g., a ‘PLANETS video, to be provided in interface 1020. Interface 1020, in some embodiments, may incorporate menus and/or user interface elements to allow a patient to access VR activities. Again, accessing a particular activity directly, rather than scrolling or inputting text for a search, can save time and effort, as well as increase safety.

In some embodiments, such as scenario 1000, accepting commands from an experienced supervisor may be more efficient, easier, and/or safer than relying on a patient to issue commands, e.g., read on-screen and/or heard from the therapist. For instance, a therapist may require a patient to participate in a particular, appropriate activity without losing too much time or focus. In some embodiments, sound 1004, e.g., in the form of a voice command, may be received from patient 1012 and/or therapist 1010.

Identifying a voice and/or authorizing a voice command in sound 1004 may be carried out in numerous ways. Generally, a VR platform and/or voice engine may receive a voice command, determine if the voice command is from an authorized user, identify a requested VR activity in the voice command if authorized, and cause the corresponding VR activity to be provided. In some embodiments, a VR platform may match the voice to a particular voice profile and/or a set of predetermined voice profiles based on audio characteristics of the voice (e.g., pitch, tone, intensity, pronunciation, etc.). In some embodiments, a VR platform may identify the location, e.g., based on amplitude and/or direction for the received audio input. In some embodiments, the VR voice engine may use multiple audio inputs like a microphone array, e.g., to triangulate a location of the voice. In some embodiments, the VR voice engine identifies the received audio input. In some embodiments, identifying the speaker of sound 1004 may use ASP/NLP and match speech characteristics to a user profile. Some embodiments may process audio to identify who issued a voice command in accordance with one or more processes described in FIGS. 4 and 9. In scenario 1000, sound 1004 is identified as being spoken by therapist 1010.

In some embodiments, upon identifying a speaker, a VR platform may determine whether the received audio input is from an authorized user. For instance, the VR platform may determine whether the received audio input is from an authorized person such as the therapist or the patient, as opposed to an observer or a bystander. In some embodiments, the VR voice engine may only authorize the patient and therapist. In some embodiments, the VR system may access user profiles and/or appointment data to identify which patient and/or therapist may be authorized. In some embodiments, the VR voice engine may only authorize the therapist. For instance, a patient who is a child or has a mental impairment may not be authorized to give voice commands. Process 900 of FIG. 9 describes an exemplary voice authorization process. In scenario 1000, therapist 1010 is authorized to issue voice commands to the VR platform, such as a voice command in sound 10004, requesting the VR platform to, e.g., “Show ‘PLANETS’ video” to patient 1012.

Processing a voice command in sound 1004 may be carried out in numerous ways. In some embodiments, processing sound 1004 as, e.g., a voice command, may use automatic speech recognition and/or natural language processing. In some embodiments, processing may include a search of the available activities based on recognized speech. In some embodiments, processing sound 1004 may comprise steps such as: converting the received audio to input text, looking up each converted word (or phrase) in a vocabulary database, and identifying words in vocabulary database in the input text. Some embodiments may process audio in accordance with one or more processes described in FIG. 3.

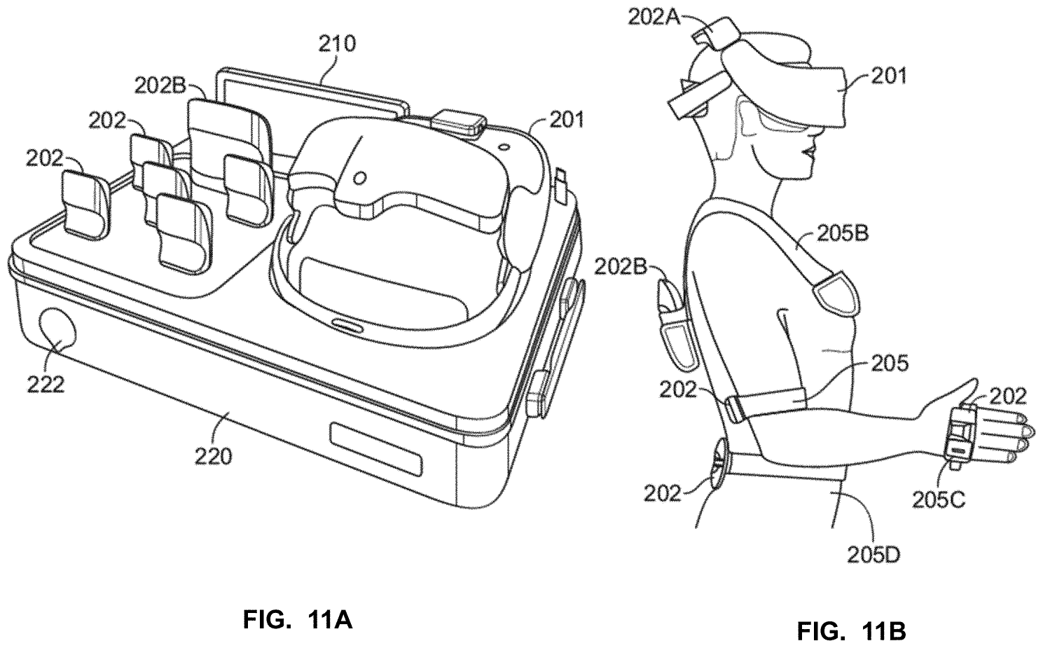

FIGS. 11A and 11B are diagrams of an illustrative system, in accordance with some embodiments of the disclosure. A VR system may include a clinician tablet 210, head-mounted display 201 (HMD or headset), small sensors 202, and large sensor 202B. Large sensor 202B may comprise transmitters, in some embodiments, and be referred to as wireless transmitter module 202B. Some embodiments may include sensor chargers, router, router battery, headset controller, power cords, USB cables, and other VR system equipment.

Clinician tablet 210 may be configured to use a touch screen, a power/lock button that turns the component on or off, and a charger/accessory port, e.g., USB-C. For instance, pressing the power button on clinician tablet 210 may power on the tablet or restart the tablet. Once clinician tablet 210 is powered on, a therapist or supervisor may access a user interface and be able to log in; add or select a patient; initialize and sync sensors; select, start, modify, or end a therapy session; view data; and/or log out.

Headset 201 may comprise a power button that turns the component on or off, as well as a charger/accessory port, e.g., USB-C. Headset 201 may also provide visual feedback of virtual reality applications in concert with the clinician tablet and the small and large sensors.

Charging headset 201 may be performed by plugging a headset power cord into the storage dock or an outlet. To turn on headset 201 or restart headset 201, the power button may be pressed. A power button may be on top of the headset. Some embodiments may include a headset controller used to access system settings. For instance, a headset controller may be used only in certain troubleshooting and administrative tasks and not necessarily during patient therapy. Buttons on the controller may be used to control power, connect to headset 201, access settings, or control volume.

The large sensor 202B (e.g., a wireless transmitter module) and small sensors 202 are equipped with mechanical and electrical components that measure position and orientation in physical space and then translate that information to construct a virtual environment. Sensors 202 are turned off and charged when placed in the charging station. Sensors 202 turn on and attempt to sync when removed from the charging station. The sensor charger may act as a dock to store and charge the sensors. In some embodiments, sensors may be placed in sensor bands on a patient. In some embodiments, sensors may be miniaturized and may be placed, mounted, fastened, or pasted directly onto a user.

As shown in illustrative FIG. 11A, various systems disclosed herein consist of a set of position and orientation sensors that are worn by a VR participant, e.g., a therapy patient. These sensors communicate with HMD 201, which immerses the patient in a VR experience. An HMD suitable for VR often comprises one or more displays to enable stereoscopic three-dimensional (3D) images. Such internal displays are typically high-resolution (e.g., 2880×1600 or better) and offer high refresh rate (e.g., 75 Hz). The displays are configured to present 3D images to the patient. VR headsets typically include speakers and microphones for deeper immersion.

HMD 201 is a piece central to immersing a patient in a virtual world in terms of presentation and movement. A headset may allow, for instance, a wide field of view (e.g., 110°) and tracking along six degrees of freedom. HMD 201 may include cameras, accelerometers, gyroscopes, and proximity sensors. VR headsets typically include a processor, usually in the form of a system on a chip (SoC), and memory. In some embodiments, headsets may also use, for example, additional cameras as safety features to help users avoid real-world obstacles. HMD 201 may comprise more than one connectivity option in order to communicate with the therapist's tablet. For instance, an HMD 201 may use an SoC that features WiFi and Bluetooth connectivity, in addition to an available USB connection (e.g., USB Type-C). The USB-C connection may also be used to charge the built-in rechargeable battery for the headset.

A supervisor, such as a health care provider or therapist, may use a tablet, e.g., tablet 210 depicted in FIG. 11A, to control the patient's experience. In some embodiments, tablet 210 runs an application and communicates with a router to cloud software configured to authenticate users and store information. Tablet 210 may communicate with HMD 201 in order to initiate HMD applications, collect relayed sensor data, and update records on the cloud servers. Tablet 210 may be stored in the portable container and plugged in to charge, e.g., via a USB plug.

In some embodiments, such as depicted in FIG. 11B, sensors 202 are placed on the body in particular places to measure body movement and relay the measurements for translation and animation of a VR avatar. Sensors 202 may be strapped to a body via bands 205. In some embodiments, each patient may have her own set of bands 205 to minimize hygiene issues.

A wireless transmitter module (WTM) 202B may be worn on a sensor band 205B that is laid over the patient's shoulders. WTM 202B sits between the patient's shoulder blades on their back. Wireless sensor modules 202 (e.g., sensors or WSMs) are worn just above each elbow, strapped to the back of each hand, and on a pelvis band that positions a sensor adjacent to the patient's sacrum on their back. In some embodiments, each WSM communicates its position and orientation in real-time with an HMD Accessory located on the HMD. Each sensor 202 may learn its relative position and orientation to the WTM, e.g., via calibration.

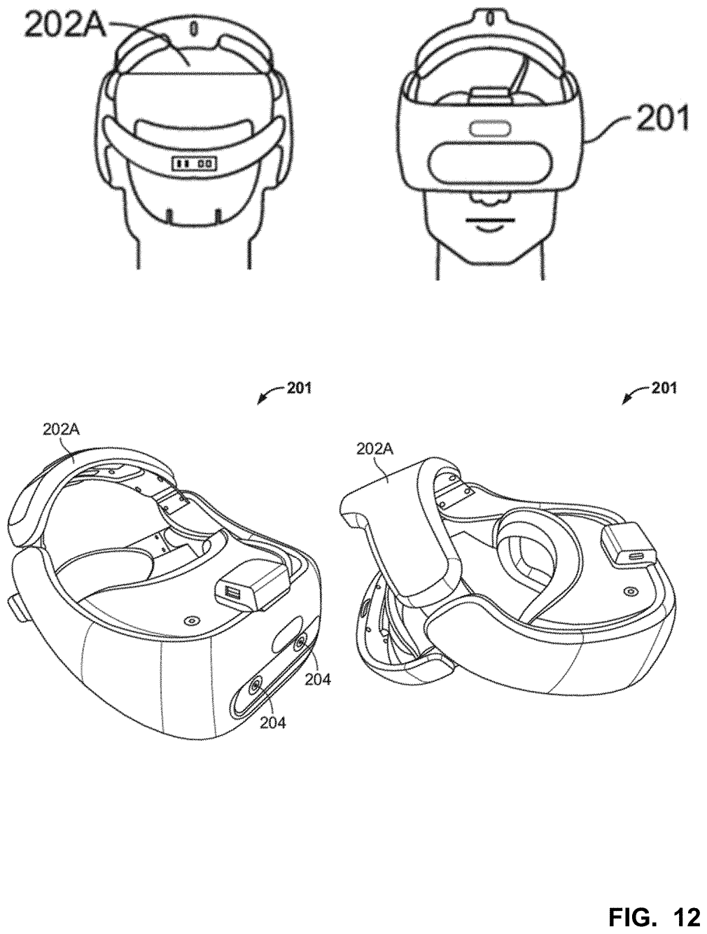

As depicted in FIG. 12, the HMD accessory may include a sensor 202A that may allow it to learn its position relative to WTM 202B, which then allows the HMD to know where in physical space all the WSMs and WTM are located. In some embodiments, each sensor 202 communicates independently with the HMD accessory which then transmits its data to HMD 201, e.g., via a USB-C connection. In some embodiments, each sensor 202 communicates its position and orientation in real-time with WTM 202B, which is in wireless communication with HMD 201. In some embodiments HMD 201 may be connected to input supplying other data such as biometric feedback data. For instance, in some cases, the VR system may include heart rate monitors, electrical signal monitors, e.g., electrocardiogram (EKG), eye movement tracking, brain monitoring with Electroencephalogram (EEG), pulse oximeter monitors, temperature sensors, blood pressure monitors, respiratory monitors, light sensors, cameras, sensors, and other biometric devices. Biometric feedback, along with other performance data, can indicate more subtle changes to the patient's body or physiology as well as mental state, e.g., when a patient is stressed, comfortable, distracted, tired, over-worked, under-worked, over-stimulated, confused, overwhelmed, excited, engaged, disengaged, and more. In some embodiments, such devices measuring biometric feedback may be connected to the HMD and/or the supervisor tablet via USB, Bluetooth, Wi-Fi, radio frequency, and other mechanisms of networking and communication.

A VR environment rendering engine on HMD 201 (sometimes referred to herein as a “VR application”), such as the Unreal Engine™, uses the position and orientation data to create an avatar that mimics the patient's movement.

A patient or player may “become” their avatar when they log in to a virtual reality activity. When the player moves their body, they see their avatar move accordingly. Sensors in the headset may allow the patient to move the avatar's head, e.g., even before body sensors are placed on the patient. A system that achieves consistent high-quality tracking facilitates the patient's movements to be accurately mapped onto an avatar.

Sensors 202 may be placed on the body, e.g., of a patient by a therapist, in particular locations to sense and/or translate body movements. The system can use measurements of position and orientation of sensors placed in key places to determine movement of body parts in the real world and translate such movement to the virtual world. In some embodiments, a VR system may collect performance data for therapeutic analysis of a patient's movements and range of motion.

In some embodiments, systems and methods of the present disclosure may use electromagnetic tracking, optical tracking, infrared tracking, accelerometers, magnetometers, gyroscopes, myoelectric tracking, other tracking techniques, or a combination of one or more of such tracking methods. The tracking systems may be parts of a computing system as disclosed herein. The tracking tools may exist on one or more circuit boards within the VR system (see FIG. 13) where they may monitor one or more users to perform one or more functions such as capturing, analyzing, and/or tracking a subject's movement. In some cases, a VR system may utilize more than one tracking method to improve reliability, accuracy, and precision.

FIG. 13 depicts an illustrative arrangement for various elements of a system, e.g., an HMD and sensors of FIGS. 11A-B and FIG. 12. The arrangement includes one or more printed circuit boards (PCBs). In general terms, the elements of this arrangement track, model, and display a visual representation of the participant (e.g., a patient avatar) in the VR world by running software including the aforementioned VR application of HMD 201.

The arrangement shown in FIG. 13 includes one or more sensors 992, processors 960, graphic processing units (GPUs) 920, video encoder/video codec 940, sound cards 946, transmitter modules 990, network interfaces 980, and light emitting diodes (LEDs) 969. These components may be housed on a local computing system or may be remote components in wired or wireless connection with a local computing system (e.g., a remote server, a cloud, a mobile device, a connected device, etc.). Connections between components may be facilitated by one or more buses, such as bus 914, bus 934, bus 948, bus 984, and bus 964 (e.g., peripheral component interconnects (PCI) bus, PCI-Express bus, or universal serial bus (USB)). With such buses, the computing environment may be capable of integrating numerous components, numerous PCBs, and/or numerous remote computing systems.

One or more system management controllers, such as system management controller 912 or system management controller 932, may provide data transmission management functions between the buses and the components they integrate. For instance, system management controller 912 provides data transmission management functions between bus 914 and sensors 992. System management controller 932 provides data transmission management functions between bus 934 and GPU 920. Such management controllers may facilitate the arrangements orchestration of these components that may each utilize separate instructions within defined time frames to execute applications. Network interface 980 may include an ethernet connection or a component that forms a wireless connection, e.g., 802.11b, g, a, or n connection (WiFi), to a local area network (LAN) 987, wide area network (WAN) 983, intranet 985, or internet 981. Network controller 982 provides data transmission management functions between bus 984 and network interface 980.

A device may receive content and data via input/output (hereinafter “I/O”) path. I/O path may provide content (e.g., content available over a local area network (LAN) or wide area network (WAN), and/or other content) and data to control circuitry 1204, which includes processing circuitry 1206 and storage 1208. Control circuitry may be used to send and receive commands, requests, and other suitable data using I/O path. I/O path may connect control circuitry (and processing circuitry) to one or more communications paths. I/O functions may be provided by one or more of these communications paths.

Control circuitry may be based on any suitable processing circuitry such as processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry executes instructions for receiving streamed content and executing its display, such as executing application programs that provide interfaces for content providers to stream and display content on a display.

Control circuitry may thus include communications circuitry suitable for communicating with a content provider server or other networks or servers. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other.

Processor(s) 960 and GPU 920 may execute a number of instructions, such as machine-readable instructions. The instructions may include instructions for receiving, storing, processing, and transmitting tracking data from various sources, such as electromagnetic (EM) sensors 993, optical sensors 994, infrared (IR) sensors 997, inertial measurement units (IMUs) sensors 995, and/or myoelectric sensors 996. The tracking data may be communicated to processor(s) 960 by either a wired or wireless communication link, e.g., transmitter 990. Upon receiving tracking data, processor(s) 960 may execute an instruction to permanently or temporarily store the tracking data in memory 962 such as, e.g., random access memory (RAM), read only memory (ROM), cache, flash memory, hard disk, or other suitable storage component. Memory may be a separate component, such as memory 968, in communication with processor(s) 960 or may be integrated into processor(s) 960, such as memory 962, as depicted.

Memory may be an electronic storage device provided as storage that is part of control circuitry. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage may be used to store various types of content described herein as well as media guidance data described above. Nonvolatile memory may also be used (e.g., to launch a boot-up routine and other instructions). Cloud-based storage may be used to supplement storage or instead of storage.

Storage may also store instructions or code for an operating system and any number of application programs to be executed by the operating system. In operation, processing circuitry retrieves and executes the instructions stored in storage, to run both the operating system and any application programs started by the user. The application programs can include one or more voice interface applications for implementing voice communication with a user, and/or content display applications which implement an interface allowing users to select and display content on display or another display.

Processor(s) 960 may also execute instructions for constructing an instance of virtual space. The instance may be hosted on an external server and may persist and undergo changes even when a participant is not logged in to said instance. In some embodiments, the instance may be participant-specific, and the data required to construct it may be stored locally. In such an embodiment, new instance data may be distributed as updates that users download from an external source into local memory. In some exemplary embodiments, the instance of virtual space may include a virtual volume of space, a virtual topography (e.g., ground, mountains, lakes), virtual objects, and virtual characters (e.g., non-player characters “NPCs”). The instance may be constructed and/or rendered in 2D or 3D. The rendering may offer the viewer a first-person or third-person perspective. A first-person perspective may include displaying the virtual world from the eyes of the avatar and allowing the patient to view body movements from the avatar's perspective. A third-person perspective may include displaying the virtual world from, for example, behind the avatar to allow someone to view body movements from a different perspective. The instance may include properties of physics, such as gravity, magnetism, mass, force, velocity, and acceleration, which cause the virtual objects in the virtual space to behave in a manner at least visually similar to the behaviors of real objects in real space.

Processor(s) 960 may execute a program (e.g., the Unreal Engine or VR applications discussed above) for analyzing and modeling tracking data. For instance, processor(s) 960 may execute a program that analyzes the tracking data it receives according to algorithms described above, along with other related pertinent mathematical formulas. Such a program may incorporate a graphics processing unit (GPU) 920 that is capable of translating tracking data into 3D models. GPU 920 may utilize shader engine 928, vertex animation 924, and linear blend skinning algorithms. In some instances, processor(s) 960 or a CPU may at least partially assist the GPU in making such calculations. This allows GPU 920 to dedicate more resources to the task of converting 3D scene data to the projected render buffer. GPU 920 may refine the 3D model by using one or more algorithms, such as an algorithm learned on biomechanical movements, a cascading algorithm that converges on a solution by parsing and incrementally considering several sources of tracking data, an inverse kinematics (IK) engine 930, a proportionality algorithm, and other algorithms related to data processing and animation techniques. After GPU 920 constructs a suitable 3D model, processor(s) 960 executes a program to transmit data for the 3D model to another component of the computing environment (or to a peripheral component in communication with the computing environment) that is capable of displaying the model, such as display 950.

In some embodiments, GPU 920 transfers the 3D model to a video encoder or a video codec 940 via a bus, which then transfers information representative of the 3D model to a suitable display 950. The 3D model may be representative of a virtual entity that can be displayed in an instance of virtual space, e.g., an avatar. The virtual entity is capable of interacting with the virtual topography, virtual objects, and virtual characters within virtual space. The virtual entity is controlled by a user's movements, as interpreted by sensors 992 communicating with the system. Display 950 may display a Patient View. The patient's real-world movements are reflected by the avatar in the virtual world. The virtual world may be viewed in the headset in 3D and monitored on the tablet in two dimensions. In some embodiments, the VR world is an activity that provides feedback and rewards based on the patient's ability to complete activities. Data from the in-world avatar is transmitted from the HMD to the tablet to the cloud, where it is stored for later analysis. An illustrative architectural diagram of such elements in accordance with some embodiments is depicted in FIG. 14.

A VR system may also comprise display 970, which is connected to the computing environment via transmitter 972. Display 970 may be a component of a clinician tablet. For instance, a supervisor or operator, such as a therapist, may securely log in to a clinician tablet, coupled to the system, to observe and direct the patient to participate in various activities and adjust the parameters of the activities to best suit the patient's ability level. Display 970 may depict a view of the avatar and/or replicate the view of the HMD.

In some embodiments, HMD 201 may be the same as or similar to HMD 1010 in FIG. 14. In some embodiments, HMD 1010 runs a version of Android that is provided by HTC (e.g., a headset manufacturer) and the VR application is an Unreal application, e.g., Unreal Application 1016, encoded in an Android package (.apk). The .apk comprises a set of custom plugins: WVR, WaveVR, SixenseCore, SixenseLib, and MVICore. The WVR and WaveVR plugins allow the Unreal application to communicate with the VR headset's functionality. The SixenseCore, SixenseLib, and MVICore plugins allow Unreal Application 1016 to communicate with the HMD accessory and sensors that communicate with the HMD via USB-C. The Unreal Application comprises code that records the position and orientation (PnO) data of the hardware sensors and translates that data into a patient avatar, which mimics the patient's motion within the VR world. An avatar can be used, for example, to infer and measure the patient's real-world range of motion. The Unreal application of the HMD includes an avatar solver as described, for example, below.

The clinician operator device, clinician tablet 1020, runs a native application (e.g., Android application 1025) that allows an operator such as a therapist to control a patient's experience. Cloud server 1050 includes a combination of software that manages authentication, data storage and retrieval, and hosts the user interface, which runs on the tablet. This can be accessed by tablet 1020. Tablet 1020 has several modules.

As depicted in FIG. 14, the first part of tablet software is a mobile device management (MDM) 1024 layer, configured to control what software runs on the tablet, enable/disable the software remotely, and remotely upgrade the tablet applications.

The second part is an application, e.g., Android Application 1025, configured to allow an operator to control the software of HMD 1010. In some embodiments, the application may be a native application. A native application, in turn, may comprise two parts, e.g., (1) socket host 1026 configured to receive native socket communications from the HMD and translate that content into web sockets, e.g., web sockets 1027, that a web browser can easily interpret; and (2) a web browser 1028, which is what the operator sees on the tablet screen. The web browser may receive data from the HMD via the socket host 1026, which translates the HMD's native socket communication 1018 into web sockets 1027, and it may receive UI/UX information from a file server 1052 in cloud 1050. Tablet 1020 comprises web browser 1028, which may incorporate a real-time 3D engine, such as Babylon.js, using a JavaScript library for displaying 3D graphics in web browser 1028 via HTML5. For instance, a real-time 3D engine, such as Babylon.js, may render 3D graphics, e.g., in web browser 1028 on clinician tablet 1020, based on received skeletal data from an avatar solver in the Unreal Engine 1016 stored and executed on HMD 1010. In some embodiments, rather than Android Application 1026, there may be a web application or other software to communicate with file server 1052 in cloud 1050. In some instances, an application of Tablet 1020 may use, e.g., Web Real-Time Communication (WebRTC) to facilitate peer-to-peer communication without plugins, native apps, and/or web sockets.

The cloud software, e.g., cloud 1050, has several different, interconnected parts configured to communicate with the tablet software: authorization and API server 1062, GraphQL server 1064, and file server (static web host) 1052.

In some embodiments, authorization and API server 1062 may be used as a gatekeeper. For example, when an operator attempts to log in to the system, the tablet communicates with the authorization server. This server ensures that interactions (e.g., queries, updates, etc.) are authorized based on session variables such as operator's role, the health care organization, and the current patient. This server, or group of servers, communicates with several parts of the system: (a) a key value store 1054, which is a clustered session cache that stores and allows quick retrieval of session variables; (b) a GraphQL server 1064, as discussed below, which is used to access the back-end database in order to populate the key value store, and also for some calls to the application programming interface (API); (c) an identity server 1056 for handling the user login process; and (d) a secrets manager 1058 for injecting service passwords (relational database, identity database, identity server, key value store) into the environment in lieu of hard coding.

When the tablet requests data, it will communicate with the GraphQL server 1064, which will, in turn, communicate with several parts: (1) the authorization and API server 1062; (2) the secrets manager 1058, and (3) a relational database 1053 storing data for the system. Data stored by the relational database 1053 may include, for instance, profile data, session data, application data, activity performance data, and motion data.

In some embodiments, profile data may include information used to identify the patient, such as a name or an alias. Session data may comprise information about the patient's previous sessions, as well as, for example, a “free text” field into which the therapist can input unrestricted text, and a log 1055 of the patient's previous activity. Logs 1055 are typically used for session data and may include, for example, total activity time, e.g., how long the patient was actively engaged with individual activities; activity summary, e.g., a list of which activities the patient performed, and how long they engaged with each on; and settings and results for each activity. Activity performance data may incorporate information about the patient's progression through the activity content of the VR world. Motion data may include specific range-of-motion (ROM) data that may be saved about the patient's movement over the course of each activity and session, so that therapists can compare session data to previous sessions' data.

In some embodiments, file server 1052 may serve the tablet software's website as a static web host.

Cloud server 1050 may also include one or more systems for implementing processes of voice processing in accordance with embodiments of the disclosure. For instance, such a system may perform voice identification/differentiation, determination of interrupting and supplemental comments, and processing of voice queries. A computing device 1100 may be in communication with an automated speech recognition (ASR) server 1057 through, for example, a communications network. ASR server 1057 may also be in electronic communication with natural language processing (NLP) server 1059 also through, for example, a communications network. ASR server 1057 and/or NLP server 1059 may be in communication with one or more computing devices running a user interface, such as a voice assistant, voice interface allowing for voice-based communication with a user, or an electronic content display system for a user. Examples of such computing devices are a smart home assistant similar to a Google Home® device or an Amazon® Alexa® or Echo® device, a smartphone or laptop computer with a voice interface application for receiving and broadcasting information in voice format, a set-top box or television running a media guide program or other content display program for a user, or a server executing a content display application for generating content for display to a user. ASR server 1057 may be any server running an ASR application. NLP server 1059 may be any server programmed to process one or more voice inputs in accordance with embodiments of the disclosure, and to process voice queries with the ASR server 1057. In some embodiments, one or more of ASR server 1057 and NLP server 1059 may be components of cloud server 1050 depicted in FIG. 14. In some embodiments, a form of one or more of ASR server 1057 and NLP server 1059 may be components of HMD 201, e.g., as depicted in FIG. 2B.

While the foregoing discussion describes exemplary embodiments of the present invention, one skilled in the art will recognize from such discussion, the accompanying drawings, and the claims, that various modifications can be made without departing from the spirit and scope of the invention. Therefore, the illustrations and examples herein should be construed in an illustrative, and not a restrictive sense. The scope and spirit of the invention should be measured solely by reference to the claims that follow.

1. A method of performing voice commands in a virtual reality (VR) platform, the method comprising:
providing a VR platform with a plurality of VR activities;
receiving, via a microphone, a first audio input from a user;
determining a first request from the first audio input;
selecting a first activity of the plurality of VR activities based on the determined first request;
providing the selected first activity of the plurality of VR activities;
receiving, via the microphone, a second audio input from a supervisor, different from the user;
determining a second request from the second audio input;
selecting a second activity of the plurality of VR activities based on the determined second request; and
providing the selected second activity of the plurality of VR activities.

2. The method of claim 1, wherein the determining a request from the audio input further comprises
converting the first audio input from speech to text; and
extracting one or more input keywords from the text.

3. The method of claim 1, wherein the selecting a first activity of the plurality of VR activities based on the determined first request further comprises selecting based on matching the one or more input keywords with metadata associated with the plurality of VR activities.

4. The method of claim 1, wherein the receiving the first audio input from the user comprises:
identifying the user;
determining whether the identified user is authorized to provide audio input;
in response to determining the identified user is authorized to provide audio input, determining the first request from the first audio input; and
in response to determining the identified user is not authorized to provide audio input, not determining the first request from the first audio input.

5. The method of claim 4, wherein the determining whether the identified user is authorized to provide audio input comprises:
accessing a voice authorization policy; and
determining whether the identified user is authorized to provide audio input based on the accessed voice authorization policy.

6. The method of claim 1, wherein receiving the second audio input from the supervisor comprises:
identifying the supervisor;
determining whether the identified supervisor is authorized to provide audio input;
in response to determining the identified supervisor is authorized to provide audio input, determining the second request from the second audio input; and
in response to determining the supervisor user is not authorized to provide audio input, not determining the second request from the second audio input.

7. The method of claim 6, wherein the determining whether the identified supervisor is authorized to provide audio input comprises:
accessing a voice authorization policy; and
determining whether the identified supervisor is authorized to provide audio input based on the accessed voice authorization policy.

8. The method of claim 1, wherein the microphone is mounted on a head-mounted display (HMD) of the user.

9. The method of claim 1, wherein the plurality of VR activities comprises at least one of the following: an activity, an exercise, a video, a multimedia experience, an application, an audiobook, a song, and a content item.

10. The method of claim 1, wherein the steps are performed in an offline mode.

11. A method of performing voice commands in a virtual reality (VR) platform, the method comprising:
providing a VR platform with a plurality of VR activities;
receiving audio input;
determining a request from the audio input;
selecting one of the plurality of VR activities based on the determined request; and
providing the selected one of the plurality of VR activities.

12. The method of claim 11, wherein the determining a request from the audio input further comprises:
determining an entity that provided the received audio input;
determining whether the determined entity is authorized to provide audio input;
in response to determining the determined entity is authorized to provide audio input, determining the request; and
in response to determining the determined entity is not authorized to provide audio input, not determining the request.

13. The method of claim 12, wherein the determining whether the determined entity is authorized to provide audio input comprises:
accessing a voice authorization policy; and
determining whether the determined entity is authorized to provide audio input based on the accessed voice authorization policy.

14. The method of claim 13, wherein the voice authorization policy is based on at least one of the following: identification, a user profile, a determined distance from a microphone, a passcode, a PIN, audio pitch, sound level, audio frequency, signal-to-noise ratio, audio intensity, and voice tone.

15. The method of claim 11, wherein the steps are performed by a head-mounted display.

16. The method of claim 11, wherein the steps are performed in an offline mode.

17. The method of claim 11, wherein the determining a request from the audio input further comprises:
converting the audio input from speech to text; and
searching for at least a portion of the text in an activity library.

18. The method of claim 17, wherein the selecting one of the plurality of VR activities based on the determined request further comprises selecting one of the plurality of VR activities based on a match from the searching for at least a portion of the text in an activity library.

19. The method of claim 11, wherein the plurality of VR activities comprises at least one of the following: an activity, an exercise, a video, a multimedia experience, an application, an audiobook, a song, and a content item.

20. The method of claim 11, wherein the audio input is received from a therapist or supervisor.

21-30. (canceled)
